(19) United States
(12) Patent Application Publication
(10) Pub. No.: US 2024/0339052 A1
(43) Pub. Date: Oct. 10, 2024

(54) DIGITAL TAG DEFECT RESOLUTION

(71) Applicant: Walmart Apollo, LLC, Bentonville, AR (US)

(72) Inventors: Jeremy L. Velten, Bella Vista, AR (US); Zorba Manolopoulos, Livermore, CA (US); Gina Smith, Fayetteville, AR (US)

(21) Appl. No.: 18/625,590

(22) Filed: Apr. 3, 2024

Related U.S. Application Data
(60) Provisional application No. 63/494,778, filed on Apr. 7, 2023.

(51) Int. Cl. G09F 3/20; G05B 23/02

(52) U.S. Cl. CPC G09F 3/208; G05B 23/0267

(57) ABSTRACT

Systems and methods for resolving defects with digital tag systems include receiving, from a digital rail, an indication of a plurality of tags having unresolved errors, prioritizing, by an error manager implemented on a processor, the plurality of tags having unresolved errors based at least in part on a type of item assigned to each tag in the plurality of tags, wherein the plurality of tags are associated with a plurality of modular displays, each modular display including at least one digital rail, the at least one digital associated with at least one tag of the plurality of tags, identifying a highest priority tag from the prioritized plurality of tags, generating a corrective action for the highest priority tag, and generating instructions for implementing the generated corrective action. The generated instructions are presented on a user interface (UI) of a user device.

### BACKGROUND

Digital tags, such as digital shelf labels (DSLs), are used to electronically present information regarding an item for sale at a retail location in lieu of similar paper labels. For example, a DSL may present one or more of price information of the item for sale, a description of the item for sale, a scannable barcode, a quick response (QR) code, stock-keeping unit (SKU) for the item for sale, and so forth. A DSL may be connected to a digital rail of a display, which provides a power source and physical location for the DSL and the item for sale, while other DSLs may standalone and include a power source without connecting to a digital rail.

### SUMMARY

The disclosed examples are described in detail below with reference to the accompanying drawing figures listed below. The following summary is provided to illustrate examples or implementations disclosed herein. It is not meant, however, to limit all examples to any particular configuration or sequence of operations.

Some examples provide a method for resolving defects with digital tag systems. The method includes receiving, from a digital rail, an indication of a plurality of tags having unresolved errors; prioritizing, by an error manager implemented on a processor, the plurality of tags having the unresolved errors based at least in part on a type of item assigned to each tag in the plurality of tags, wherein the plurality of tags are associated with a plurality of modular displays, each modular display including at least one digital rail, the at least one digital rail associated with at least one tag of the plurality of tags; identifying, by the error manager, a highest priority tag from the prioritized plurality of tags; generating, by the error manager, a corrective action for the highest priority tag; and generating, by the error manager, instructions for implementing the generated corrective action, wherein the generated instructions are presented on a user interface (UI) of a user device.

Other examples provide a system for resolving defects with digital tag systems. The system includes a user interface (UI) implemented on a user device, a memory, and a processor communicatively coupled to the memory, and an error manager, implemented on the processor, operable to: receive, from a digital rail, an indication of a plurality of tags having unresolved errors; prioritize the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags; identify a highest priority tag from the prioritized plurality of tags; generate a corrective action for the highest priority tag; and generate instructions for implementing the generated corrective action, wherein the generated instructions are presented on the UI of the user device.

Other examples provide a computer-readable storage medium having computer-executable instructions for resolving defects with digital tag systems. The instructions, upon execution by a processor, cause the processor to: receive, from a digital rail, an indication of a plurality of tags having unresolved errors; prioritize, by an error manager implemented on the processor, the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags; identify a highest priority tag from the prioritized plurality of tags; generate a corrective action for the highest priority tag; determine a location of the highest priority tag; determine a present location of a user device; and generate navigation instructions from the present location of the user device to the location of the highest priority tag; and generate instructions for implementing the generated corrective action, wherein the generated instructions and the generated navigation instructions are presented on a user interface (UI) of a user device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a system for resolving defects with digital tag systems according to an example;

FIG. 2 is a block diagram illustrating a digital rail according to an example;

FIG. 3 is a block diagram illustrating a digital tag according to an example;

FIG. 4 is a block diagram illustrating a digital tag according to an example;

FIG. 5 is a display illustrating a plurality of digital rails and digital tags according to an example;

FIGS. 6A-6B are a flow chart illustrating a method of resolving defects with digital tag systems according to an example;

FIG. 7 is a flow chart illustrating a method of resolving defects with digital tag systems according to an example;

FIG. 8 is a flow chart illustrating a method of generating navigation instructions for resolving defects with digital tag systems according to an example;

FIG. 9 is a flow chart illustrating a method of presenting a user interface (UI) with instructions for resolving defects with digital tag systems according to an example;

FIG. 10 is a flow chart illustrating a method of identifying an error type and presenting a UI with instructions for resolving the identified error type according to an example;

FIG. 11 illustrates a user interface according to an example; and

FIG. 12 is a block diagram of an example computing device for implementing implementations of the present disclosure.

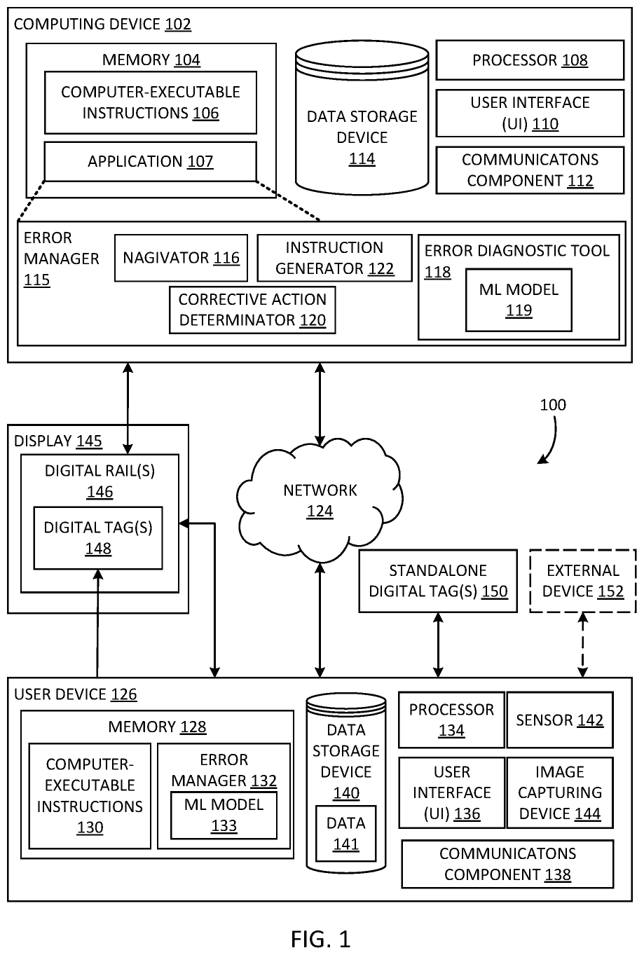

Corresponding reference characters indicate corresponding parts throughout the drawings. In FIGS. 1 to 12, the systems are illustrated as schematic drawings. The drawings may not be to scale.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all implementations.

The foregoing summary, as well as the following detailed description of certain will be better understood when read in conjunction with the appended drawings. As used herein, an element or step recited in the singular and preceded by the word “a” or “an” should be understood as not necessarily excluding the plural of the elements or steps. Further, references to an implementation or an example are not intended to be interpreted as excluding the existence of additional examples that also incorporate the recited features. Moreover, unless explicitly stated to the contrary, examples “comprising” or “having” an element or a plurality of elements having a particular property could include additional elements not having that property.

As noted herein, a digital tag, such as a DSL presents information regarding an associated item for sale at a retail location, such as price, description, SKU, a barcode, a QR code, and so forth. Some examples of a digital tag are connected to a digital rail, which provide a power source and physical location for attachment of the digital tag, while other examples of a digital tag may standalone and include a power source without connecting to a digital rail. A digital rail is presented on an end of each shelf of an item display, such as on an aisle, on an end-cap of an aisle, a standalone display, an end of a peg, and so forth. Other examples of a digital tag are standalone digital tags, which provide the information regarding an associated item for sale without the need to be connected to the digital rail by including internal hardware and electrical components to power the functions of the digital tag. In some instances, an error may be detected that impacts proper functionality of the digital tag. For example, an error may be an error with the digital tag itself or an error with the digital rail associated with the digital tag. Errors with the digital tag or digital rail can lead to confusion about the description, price, etc. Of an associated item for sale at the retail location.

Current solutions for correcting errors with digital tags typically include merely replacing a digital tag that is failing to properly display information regarding the item for sale. However, these solutions fail to take into account the cause of the error and thus fail to properly provide instructions on how to resolve the error. For example, the current solutions fail to take into account potential issues with the digital rail itself that cause the digital tag to fail to properly display information and do not provide a mechanism to attempt to address the failure without replacement of the digital tag. This leads to waste, as some digital tags that otherwise are not malfunctioning are discarded, while the underlying problem persists and is not corrected.

Various examples of the present disclosure provide systems and methods for resolving defects with digital tags. The method includes a process of receiving a notification from a digital tag or a digital rail indicating an error and presenting, on a user interface (UI) of an electronic device, instructions for diagnosing, or predicting, and correcting, or resolving, the error. Accordingly, the present disclosure provides an improved user interface of a mobile electronic device that presents an indication of an error associated with a digital tag on a digital rail associated with a portion of a modular display, predicts an error type based on an input received on the UI, and determines a recommended corrective action to resolve the predicted error type. By predicting the error type and determining a recommended corrective action to resolve the predicted error type, the present disclosure reduces resource usage, i.e., processor, memory, and network usage, reduces error rates of the digital tag system, and enhances reliability of the digital tag system, by providing improved mechanisms of error handling and error correction. The present disclosure further reduces waste by providing the dynamic user interface that presents instructions to correct some errors without replacing each digital tag or digital rail presenting an error, resulting in less waste and reduced costs than current solutions.

The present disclosure further provides improved systems for prioritizing errors with digital tags and digital rails and generating navigation instructions to the highest prioritized error. These systems, which generate a queue of errors based on the determined priority of each received error and then generate navigation instructions to minimize the time and/or distance required to arrive at the next prioritized error, result in improvements in user interactions by improving user efficiency through the instructions presented on the dynamic user interface and reducing error rates by more efficiently resolving the predicted errors and resolving the predicted errors based on a determined priority.

The present disclosure further provides improved systems for predicting errors with digital tag systems. The present disclosure discloses an error resolution application that includes a machine learning (ML) model that receives feedback regarding a predicted error type and uses the received feedback to update predicted error types for future iterations of error predictions. Accordingly, error resolution application is continually improved to provide more accurate error predictions, which reduces resource usage, i.e., processor, memory, and network usage, to predict errors, reduces error rates of the digital tag system, and enhances reliability of the digital tag system, by providing improved mechanisms of error prediction.

The present disclosure operates in an unconventional manner by predicting the cause of digital tag or digital rail errors and providing a recommended solution for restoring function, i.e., correcting or eliminating the error, of the digital tag or digital rail, thereby reducing the number of digital tags and digital rails which are discarded and replaced. The recommended solution is presented on a dynamic user interface on an electronic device that, based on input and feedback received via the user interface, provides real-time and intelligent instructions that can aid in resolution of the predicted error. The instructions are presented via the user interface of a client-side application. In some examples, the server-side version of the application receives inputs received at the client-side version of the application to diagnose the error, generate a corrective action, and generate instructions for implementing the corrective action.

FIG. 1 is an exemplary block diagram illustrating a system for resolving defects with digital tag systems. The system 100 illustrated in FIG. 1 is for illustration only. Other examples of the system 100 can be used without departing from the scope of the present disclosure.

FIG. 1 illustrates a computing device 102 that represents any device executing computer-executable instructions 106 (e.g., as application programs, operating system functionality, or both) to implement the operations and functionality associated with the computing device 102. In some examples, the computing device 102 is a server, desktop personal computer, kiosk, or tabletop device. In some examples, the computing device 102 is a mobile computing device or any other portable device. A mobile computing device can include, for example but without limitation, a mobile telephone, laptop, tablet, computing pad, netbook, gaming device, and/or portable media player. In some examples, the computing device 102 represents a group of processing units or other computing devices.

In some examples, the computing device 102 includes a memory 104, a processor 108, a user interface 110, a communications component 112, and a data storage device 114. The processor 108 includes any quantity of processing units and is programmed to execute computer-executable instructions 106 stored in the memory 104. The computer-executable instructions 106 are executed, or performed, by the processor 108, performed by multiple processors 108 within the computing device 102, or performed by a processor external to the computing device 102.

The memory 104 includes any quantity of media associated with or accessible by the computing device 102. In some examples, the memory 104 is internal to the computing device 102, as shown in FIG. 1. In other examples, the memory 104 is external to the computing device 102 or both external and internal. The memory 104 can include read-only memory and/or memory wired into an analog computing device. The memory 104 stores data, such as one or more applications 107. The application 107, when executed by the processor 108, operates to perform functionality on the computing device 102. The application 107 can communicate with counterpart applications or services such as web services accessible via a network 124. In an example, the application 107 represents server-side services executing in a cloud. The error manager 115, described in greater detail below, is an example of the application 107.

In some examples, the user interface 110 includes a graphics card for displaying data to a user and receiving data from the user. The user interface 110 can also include computer-executable instructions, for example a driver, for operating the graphics card. The user interface 110 can further include a display, for example a touch screen display or natural user interface, and/or computer-executable instructions, for example a driver, for operating the display. The user interface 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The communications component 112 includes a network interface card and/or computer-executable instructions, for example a driver, for operating the network interface card. Communication between the computing device 102 and other devices, such as but not limited to a user device 126 or digital rail 146, can occur using any protocol or mechanism over any wired or wireless connection. In some examples, the communications component 112 is operable with short range communication technologies such as by using near-field communication (NFC) tags. In some examples, the communications component 112 includes a transceiver configured to transmit and receive signals, such as via the network 124.

The data storage device 114 includes one or more different types of data storage devices, such as, for example, one or more rotating disks drives, one or more solid state drives (SSDs), and/or any other type of data storage device. The data storage device 114, in some non-limiting examples, includes a redundant array of independent disks (RAID) array. In other examples, the data storage device 114 includes a database. The data storage device 114 in this example is included within the computing device 102, attached to the computing device, plugged into the computing device, or otherwise associated with the computing device 102. In other examples, the data storage device 114 includes a remote data storage accessed by the computing device 102 via the network 124, such as a remote data storage device, a data storage in a remote data center, or a cloud storage. In some examples, the data storage device 114 stores data associated with one or more digital rails 146, one or more digital tags 148, one or more standalone digital tags 150, and items associated with a digital tag 148 or standalone digital tag 150. For example, the data storage device 114 stores associations between digital tags and items, digital tags, and a digital rail 146, different errors and associated recommended corrective actions, and recommended corrective actions and associated instructions that, when performed, implement the recommended corrective action for the respective error.

The computing device 102 further includes an error manager 115 that includes a navigator 116, an error diagnostic tool 118, a corrective action determinator 120, and an instruction generator 122. In some examples, the error manager 115 is an example of an application 107 stored on the memory and executed by the processor 108. For example, the error manager 115 is a specialized software application stored on the memory 104 and executed by the processor 108 that associates a digital tag to an item and/or a digital rail, removes associations between the digital tag and the item and/or the digital rail, and presents instructions to resolve defects in the digital tag and/or the digital rail.

Each of the navigator 116, error diagnostic tool 118, corrective action determinator 120, and instruction generator 122 are specialized software components executed as examples of the computer-executable instructions 106 executed by the processor 108 to perform a specialized function. For example, the navigator 116 is a specialized software component that is used to prepare navigation instructions to a particular location. The location may be associated with a particular digital rail 146, digital tag 148, standalone digital tag 150, item for sale, and so forth within a retail location. In one example, the location is a location within a retail location at which an item for sale is placed upon a digital rail 146 that is coupled to a digital tag 148 that presents a description and price of the item for sale. The navigator 116 generates navigation instructions from a starting point, such as a current location of an user device 126 or a default starting location, to the particular location. In some examples, the navigator 116 generates the navigation instructions in response to receiving a request for navigation instructions from the user device 126. In other examples, the navigator 116 generates the navigation instructions in response to a trigger, such as an indication that a digital tag 148 has been linked to an item, that a digital tag 148 has been linked to a digital rail 146, in response to an application 107 being opened, and so forth.

The error diagnostic tool 118 predicts an error that has occurred with one or more of a digital rail 146, a digital tag 148, or a standalone digital tag 150. The predicted error is a prediction of the type of error present, i.e., an error with a digital rail 146, an error with a digital tag 148, or an error with a standalone digital tag 150. In some examples, the predicted error further includes a prediction of a subtype of error. For example, a digital rail error may have subtypes of errors such as a rail battery error or a non-rail battery error.

In some examples, the error diagnostic tool 118 predicts the error based on feedback received from the user device 126 or the digital rail 146. In one example, to predict the error, the error diagnostic tool 118 determines whether the error is an error occurring with the digital rail 146, the digital tag 148, or the standalone digital tag 150. In some examples, the error diagnostic tool 118 includes a machine learning (ML) model 119 that improves error predicting based on feedback received that indicates a successful prediction or an unsuccessful prediction from previous iterations of error prediction. In these examples, the predicted error by the error diagnostic tool 118 is updated or modified based on additional information, including the received feedback, that results in a change to the initial prediction.

The corrective action determinator 120 determines a recommended corrective action based on the predicted error type predicted by the error diagnostic tool 118. A digital rail error is corrected by a different corrective action than a digital tag error. For example, a digital rail error may be corrected by replacing the digital rail 146, reseating a battery 208 of the digital rail 146, replacing the battery 208 of the digital rail 146, and so forth, while a digital tag error may be corrected by reseating the digital tag 148 on the digital rail 146 or replacing the digital tag 148 with a new digital tag 148. In some examples, the corrective action determinator 120 obtains the recommended corrective action from the data storage device 114 for the predicted error.

The instruction generator 122 generates instructions that, when performed, implement the recommended corrective action determined by the corrective action determinator 120. The generated instructions are a step by step guide for implementing the recommended corrective action. In some examples, the generated instructions are transmitted to the user device 126 for presentation on an interface, such as a user interface (UI) 136 described in greater detail below. A user, such as a retail associate, may retrieve the generated instructions, which are then presented on the user interface 136, and follow the presented generated instructions to resolve the predicted error type.

The network 124 is implemented by one or more physical network components, such as, but without limitation, routers, switches, network interface cards (NICs), and other network devices. The network 124 is any type of network for enabling communications with remote computing devices, including the computing device 102 and the user device 126, such as, but not limited to, a local area network (LAN), a subnet, a wide area network (WAN), a wireless (Wi-Fi) network, Bluetooth™, or any other type of wireless network. In this example, the network 124 is a WAN, such as the Internet. However, in other examples, the network 124 is a local or private LAN. In some examples, the network 124 is a cloud network environment.

The user device 126 represents any device executing computer-executable instructions. The user device 126 can be implemented as a mobile computing device, such as, but not limited to, a wearable computing device, a mobile telephone, laptop, tablet, computing pad, netbook, gaming device, and/or any other portable device. The user device 126 includes a memory 128, a processor 134, a user interface 136, a communications component 138, and a data storage device 140. The processor 134 includes any quantity of processing units and is programmed to execute computer-executable instructions 130 stored in the memory 128. The computer-executable instructions 130 are executed, or performed, by the processor 134, performed by multiple processors 134 within the user device 126, or performed by a processor external to the user device 126.

The memory 128 includes any quantity of media associated with or accessible by the user device 126. In some examples, the memory 128 is internal to the user device 126, as shown in FIG. 1. In other examples, the memory 128 is external to the user device 126 or both external and internal. The memory 128 can include read-only memory and/or memory wired into an analog computing device. The memory 128 stores data, such as one or more applications including an error manager 132. The error manager 132, when executed by the processor 134, operates to perform functionality on the user device 126. The error manager 132 can communicate with counterpart applications or services such as web services accessible via the network 124. In an example, the error manager 132 represents a downloaded client-side version of the error manager 115 server-side services executing in a cloud. For example, the error manager 132 can include an application that is used to associate a digital tag to an item and/or a digital rail, remove associations between the digital tag and the item and/or the digital rail, and present instructions to resolve defects in the digital tag and/or the digital rail. In some examples, the error manager 132 includes a ML model 133 that improves error predicting based on feedback received that indicates a successful prediction or an unsuccessful prediction from previous iterations of error prediction. In these examples, the predicted error by the error manager 132 is updated or modified based on additional information, including the received feedback, which results in a change to the initial prediction.

In some examples, the user interface 136 includes a graphics card for displaying data to a user and receiving data from the user. The user interface 136 can also include computer-executable instructions, for example a driver, for operating the graphics card. The user interface 136 can further include a display, for example a touch screen display or natural user interface, and/or computer-executable instructions, for example a driver, for operating the display. The user interface 136 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the user device 126 in one or more ways.

In some examples, the user interface 136 presents an interface of the error manager 132. The interface of the error manager 132 presents navigation instructions, generated by the navigator 116, to navigate to a location that has an error, presents selectable prompts that, when selected by a user, are used by the error diagnostic tool 118, and presents instructions, generated by the instruction generator 122, that, when followed and implemented by a user, correct the diagnosed error.

The communications component 138 includes a network interface card and/or computer-executable instructions, for example a driver, for operating the network interface card. Communication between the user device 126 and other devices, such as but not limited to the computing device 102, digital rail 146, digital tag 148, and standalone digital tag 150, can occur using any protocol or mechanism over any wired or wireless connection. In some examples, the communications component 138 is operable with short range communication technologies such as by using near-field communication (NFC) tags. In some examples, the communications component 138 includes a transceiver configured to transmit and receive signals, such as via the network 124.

The data storage device 140 includes one or more different types of data storage devices, such as, for example, one or more rotating disks drives, one or more solid state drives (SSDs), and/or any other type of data storage device. The data storage device 140, in some non-limiting examples, includes a redundant array of independent disks (RAID) array. In other examples, the data storage device 140 includes a database. The data storage device 140 in this example is included within the user device 126, attached to the computing device, plugged into the computing device, or otherwise associated with the user device 126. In other examples, the data storage device 140 includes a remote data storage accessed by the user device 126 via the network 124, such as a remote data storage device, a data storage in a remote data center, or a cloud storage.

The user device 126 further includes a sensor 142 and an image capturing device 144. In some examples, the sensor 142 is a location sensor, such as a global positioning system (GPS) unit. A location of the user device 126 is determined via the sensor 142, transmitted to the computing device 102 via the communications component 138, and used by the navigator to generate real-time instructions on how to navigate from a present location to a location of an identified error. In some examples, data from the sensor 142 is used by the error manager 132 to detect when the user device 126 has arrived at the location of the identified error and, upon the detection of the user device 126 arriving at the location of the identified error, the error manager 132 presents, on the user interface 136, a selectable prompt to confirm the presence of the identified error and/or a selectable prompt to be used to diagnose the identified error.

The image capturing device 144 captures an image of a barcode presented on a digital rail 146, a digital tag 148, a standalone digital tag 150, or an item for sale, and a site of an error to be resolved. In some examples, the image capturing device 144 is or includes a camera, a scanner, and so forth to capture an image of the error site or a barcode. For example, the scanned barcode is used to associate the digital rail 146 with an item for sale, a digital tag 148, or a standalone digital tag 150, to associate the digital tag 148 with an item for sale or a digital rail 146, or to associate the standalone digital tag 150 with an item for sale. In another example, the captured image of an error site is analyzed by the processor 134 to identify an error type, identify whether an error has been resolved, and so forth.

In some examples, the digital rail 146 is mounted on a display 145. The display 145 is a modular display that includes shelving or a portion of shelving. As referenced herein, the term modular refers to the ability of the display 145 to be modified, replaced, exchanged, and so forth based on the location of the display 145, the items to be presented on the display 145, and so forth. In some examples, the display 145 is associated with an aisle of a retail location to provide various items to be selected and purchased by a consumer. In other examples, the display 145 is an end-cap of an aisle or as a standalone display on a salesfloor of a retail environment. The display 145 may include a single digital rail 146 or a plurality of digital rails 146. For example, the display 145 can include a single digital rail 146 and a single associated digital tag 148, a single digital rail 146 having multiple associated digital tags 148, multiple digital rails 146 each having a single associated digital tag 148, or multiple digital rails 146, some of which have a single associated digital tag 148 and some of which have multiple associated digital tags 148. In some examples described herein, a physical location of a digital rail 146 or of an identified error refers to a physical location of the display 145 upon which the digital rail 146 is mounted within a retail environment.

In some examples, the system 100 includes an external device 152. The external device 152 may be an automated electronic device such as a robot operable to receive and follow instructions to resolve defects and errors with digital tag 148, standalone digital tag 150, or digital rail 146. The external device 152 may include a processor, a memory, a propulsion mechanism such as wheels and a motor that powers the wheels, a robotic arm operable to perform functions including replacing a digital rail 146, a digital tag 148, and a standalone digital tag 150, reseating a battery 208 on a digital rail 146, reseating a digital tag 148 on a digital rail 146, and so forth, and an image capturing device operable to capture an image of an error site, capturing an image of a resolved error site.

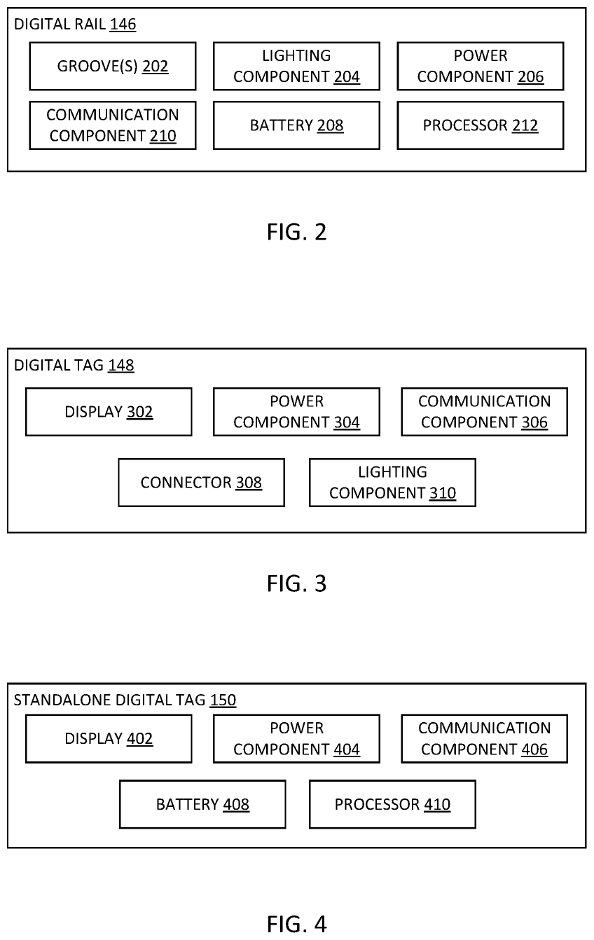

FIG. 2 is an example block diagram illustrating a digital rail according to an example. The example digital rail 146 illustrated in FIG. 2 is for illustration only. Other examples of the digital rail 146 can be used without departing from the scope of the present disclosure.

The digital rail 146 is an extended member comprising metal, such as aluminum, steel, and/or copper, or plastic. The digital rail 146 is provided on one end of a shelf, or display, such as the display 145, and operable to removably couple to a digital price tag, such as the digital tag 148. As illustrated in FIG. 2, the digital rail 146 includes one or more grooves 202, a lighting component 204, a power component 206, a battery 208, a communication component 210, and a processor 212. Each of the one or more grooves 202 is a recessed portion extending length-wise along a bottom portion of the digital rail 146. Each of the one or more grooves 202 is configurable to accommodate a connection portion of the digital tag 148, such as the connector 308. In some examples, each of the one or more grooves 202 includes an electrical connection portion that electrically connects to the digital tag 148 and provides a power source for the digital tag 148.

The lighting component 204 includes a light that lights the shelf, or display, area of the digital rail 146. The light may include a light emitting diode (LED) light, an incandescent light bulb or bulbs, and so forth. In some examples, the lighting component 204 is operable to emit different colored lights. For example, a first color, such as green, indicates an error is not present on the digital rail 146, a second color, such as red, indicates an error is present on the digital rail 146, and a third color, such as yellow, indicates a previous error is in the process of being corrected. The power component 206 is connected to the battery 208 and includes power wires that provide power from the battery 208 to the electrical components of the digital rail 146, i.e., the communication component 210 and processor 212. For example, the connector 308 of the digital tag 148 slides into one of the grooves 202, locks in via the connector 308, and contacts the power component 206 to provide power and communication to the digital tag 148. The communication component 210 is controlled by the processor 212 to transmit a notification signal, such as an error signal, to the computing device 102 or the user device 126 indicating an error issue.

FIG. 3 is an example block diagram illustrating a digital tag according to an example. The example digital tag 148 illustrated in FIG. 3 is for illustration only. Other examples of the digital tag 148 can be used without departing from the scope of the present disclosure.

The digital tag 148 may also be referred to as a digital display tag, digital price tag, a digital shelf label (DSL), or a digital shelf tag. In some examples, the digital tag 148 displays information regarding a particular item at a retail location. In some examples, the item is an item for sale, an item for rent or lease, an item available for free, a display only item, and so forth. The digital tag 148 includes a display 302 that presents information regarding the associated, or linked, item. The display 302 may be a liquid crystal display (LCD), an electronic paper display, or any other suitable display type to present item information. In some examples, the display 302 uses electronic inking technology to present various item information, including but not limited to an item name, item description, item price, barcode, quick response (QR) code, item SKU, and so forth.

The digital tag 148 further includes a power component 304, a communication component 306, the connector 308, and a lighting component 310. The power component 304 provides power for the digital tag 148 through a connection with the power component 206 of the digital rail 146 when the digital tag 148 is inserted in one of the grooves 202 of the digital rail 146. For example, the power component 304 includes one or more contact points that come in contact with contact points of the power component 206 to enable an electrical current to be passed through to the digital tag 148. The communication component 306 enables communication with a device that links the digital tag 148 to a particular item and location on the digital rail 146. In some examples, the communication component 306 is a barcode or QR code presented on the digital tag 148. For example, the digital tag 148 may be linked with a particular item and location on the digital rail 146 by the image capturing device 144 of the user device 126 scanning the communication component 306, scanning a barcode or QR code on a particular location of the digital rail 146, and scanning a barcode or QR code of the item for sale. A prompt may then be selected on the user interface 136 confirming the linkage of the digital tag 148, the digital rail 146, and the item for sale. The lighting component 310 may include a light emitting diode (LED) light, an incandescent light bulb or bulbs, and so forth. In some examples, the lighting component 310 flashes or continuously presents light to indicate a successful connection with the digital rail 146.

FIG. 4 is an example block diagram illustrating a digital tag according to an example. The example standalone digital tag 150 illustrated in FIG. 4 is for illustration only. Other examples of the standalone digital tag 150 can be used without departing from the scope of the present disclosure.

The standalone digital tag 150 displays information regarding a particular item for sale at a retail location. In relation to the digital tag 148, the standalone digital tag 150 is operable as a standalone device. In other words, the standalone digital tag 150 includes a power source and processor 410, enabling the standalone digital tag 150 to provide item information without being coupled to a digital rail 146. The standalone digital tag 150 includes a display 402 that presents information regarding the associated, or linked, item for sale. The display 402 may be a liquid crystal display (LCD), an electronic paper display, or any other suitable display type to present item information. In some examples, the display 402 uses electronic inking technology to present various item information, including but not limited to an item name, item description, item price, barcode, quick response (QR) code, item SKU, and so forth.

The standalone digital tag 150 further includes a power component 404, a communication component 406, a battery 408, and a processor 410. The power component 404 includes an electrical connection to an electrical outlet or other external power source to provide power to the standalone digital tag 150. The battery 408 is provided to provide power to the standalone digital tag 150 in the event that an external power source is unavailable. The communication component 406 is controlled by the processor 410 to communicate with one or more of the computing device 102, user device 126, or other device in order to communicate a notification of an error, receive updated item information, and so forth.

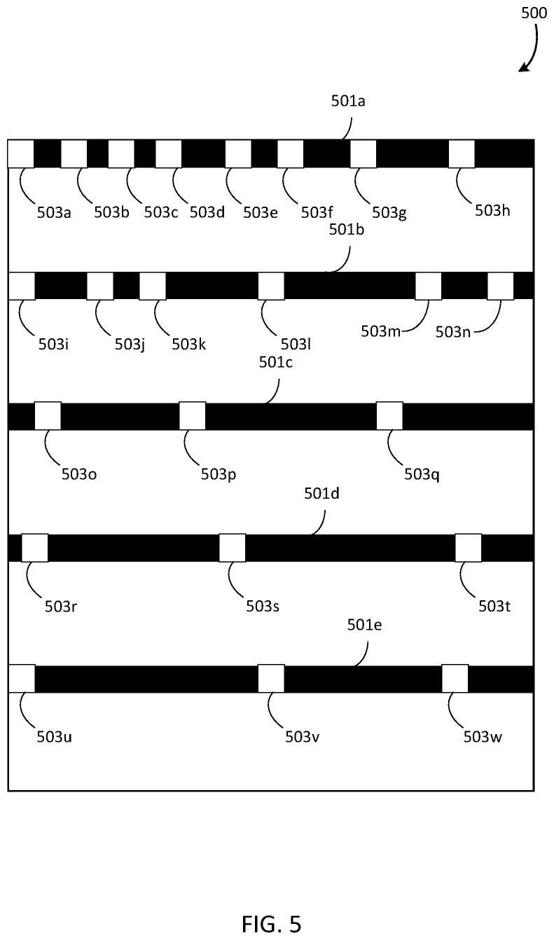

FIG. 5 is an example display illustrating a plurality of digital rails and digital tags according to an example. The example display 500 illustrated in FIG. 5 is for illustration only. Other examples of the display 500 can be used without departing from the scope of the present disclosure. In some examples, the display 500 is an example of the display 145, such as a modular display.

The display 500 includes a plurality of digital rails 501a-501e and digital tags 503a-503w. Each digital rail 501 may be an example of the digital rail 146 described herein and each digital tag 503 may be an example of the digital tag 148 described herein. In some examples, each digital tag 503 is linked to, or associated with, a particular digital rail 501 and a particular item for sale that is stored on the display 500 in a location proximate to the digital tag 503.

As illustrated in FIG. 5, the display 500 includes five digital rails 501a, 501b, 501c, 501d, 501c, but various examples are possible. The display 500 may include more or fewer than five digital rails 501 without departing from the scope of the present disclosure. The display 500 further includes twenty-three digital tags 503a, 503b, 503c, 503d, 503c, 503f, 503g, 503h, 503i, 503j, 503k, 5031, 503m, 503n, 503o, 503p, 503q, 503r, 503s, 503t, 503u, 503v, 503w, but various examples are possible. The display 500 may include more or fewer than twenty-three digital tags 503 without departing from the scope of the present disclosure. As illustrated in FIG. 5, each digital tag 503 has been inserted into a groove 202 of a respective digital rail 501 and powered on via a connection from the connector 308 to the power component 206.

In some examples, the display 500 is presented as shelving or a portion of shelving associated with an aisle of a retail location to provide various items to be selected and purchased by a consumer. In other examples, the display 500 is presented on an end-cap of an aisle or as a standalone display on a salesfloor of a retail environment. Although described herein as including a plurality of digital rails 146 and a plurality of associated digital tags 148, various examples are possible. For example, a display 500 can include a single digital rail 146 and a single associated digital tag 148, a single digital rail 146 having multiple associated digital tags 148, multiple digital rails 146 each having a single associated digital tag 148, or multiple digital rails 146, some of which have a single associated digital tag 148 and some of which have multiple associated digital tags 148.

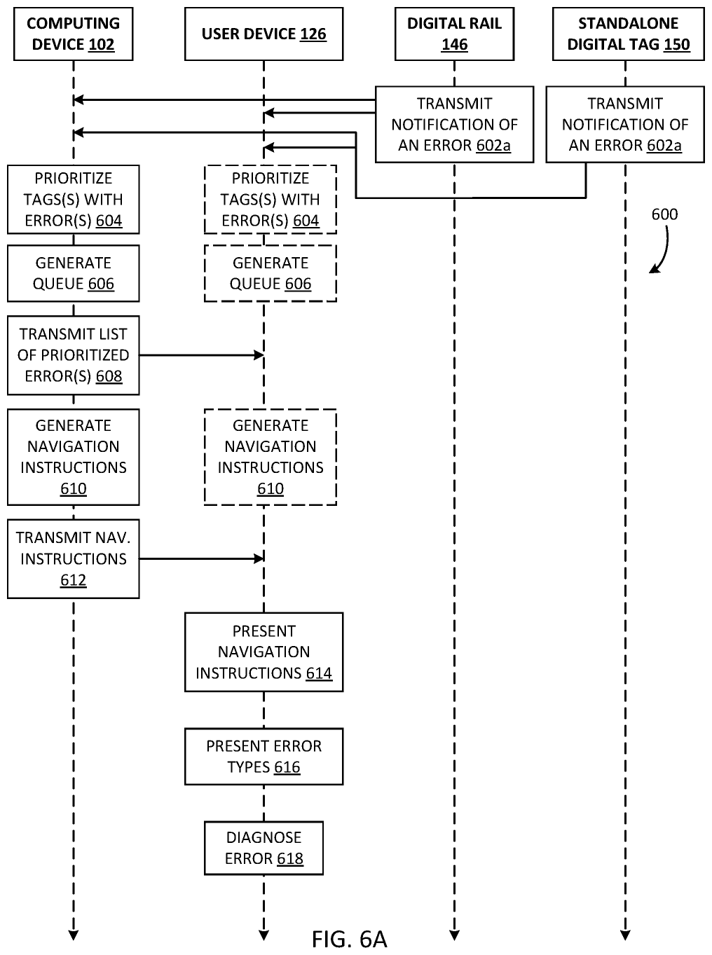

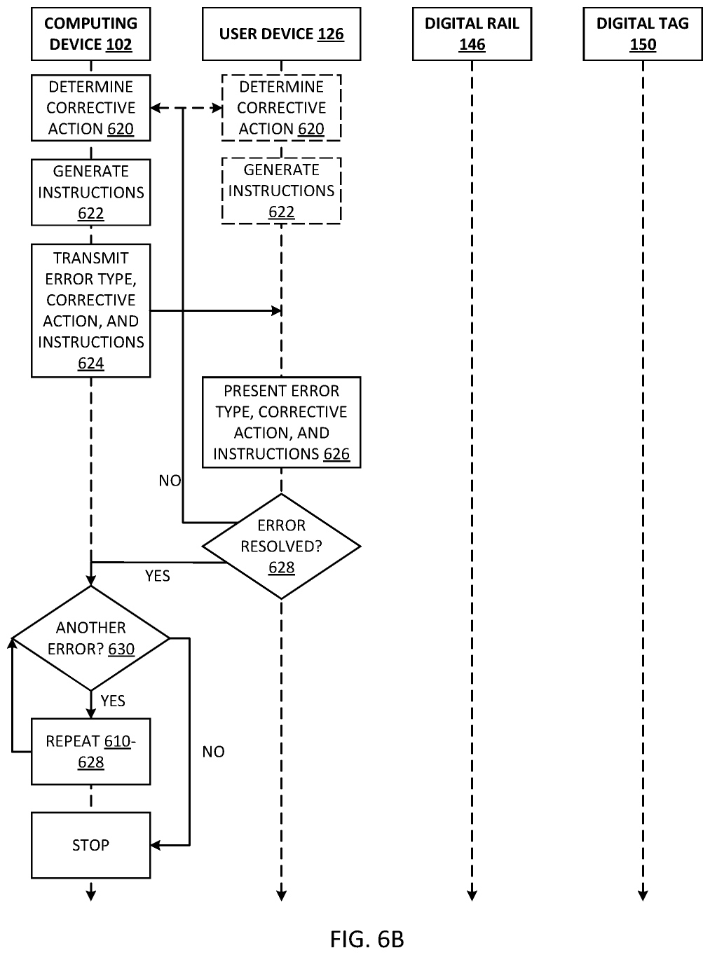

FIGS. 6A-6B are an example flow chart illustrating a method of resolving defects with digital tag systems according to an example. The method 600 illustrated in FIGS. 6A and 6B is for illustration only. FIG. 6B extends FIG. 6A and is a continuation of the method 600 which begins in FIG. 6A. Other examples of the method 600 can be used without departing from the scope of the present disclosure. In some examples, the method 600 is implemented by one or more components of the system 100 illustrated in FIG. 1.

The method 600 begins by one or both of the digital rail 146 or the standalone digital tag 150 transmitting, to one or both of the computing device 102 and the user device 126, a notification of an error in operation 602. For example, in operation 602a, the digital rail 146 transmits the notification to the computing device 102, and in operation 602b, the digital rail 146 transmits the notification to the computing device 102. In various examples, the method 600 begins by operation 602a being performed, operation 60b being performed, or each of operations 602a and 602b being performed. In some examples, multiple notifications of errors are received at a time.

In operation 604, the computing device 102 receives the notification of the one or more errors from one or both of the digital rail 146 or the standalone digital tag 150 and prioritizes the tags having unresolved errors. In some examples, the computing device 102 generates a queue of tags having unresolved errors ordered from a highest priority to a lowest priority in operation 606. In some examples, receiving and prioritizing the identified errors into the queue is referred to as triaging the identified tags having unresolved errors. The computing device 102 prioritizes the errors based on various factors that may be predetermined or set by a user, such as a retail associate using the user device 126 or a manager of the retail associate. In one example, the prioritization is based on physical proximity of location to the user device 126, including a same department of the retail location or a product category of the items associated with the errors, as an error is likely to be located in close proximity to another error in a same product category. Various examples of departments may include clothing, groceries, household items, toys, and so forth, while various examples of product categories may include categories such as toothpaste, men's shirts, women's shoes, televisions, fishing hooks, and so forth. This prioritization method prioritizes errors that are able to be addressed quickly due to a physical proximity to an electronic device utilized by a retail associate that provides instructions on correcting the error. In this example, a first error is prioritized, a second error is prioritized due to its proximity to the first error, and so forth. Accordingly, this example provides an ordered list of the most efficient manner in which the errors are to be addressed, minimizing wasted time and travel distance between each error. In another example, the prioritization is based on an anticipated severity of the error. For example, an error with the digital rail 146 may be prioritized higher than an error with the standalone digital tag 150 because the error with the digital rail 146 has the potential to affect multiple digital tags 148, while an error with the standalone digital tag 150 affects only a single tag, i.e., the standalone digital tag 150 that reports the error. In another example, the prioritization is based on a profit or profit margin of an item associated with each error. For example, where two errors are received, the error associated with the item having a greater profit is prioritized over the error associated with the item having a lesser profit. The computing device 102 generates a queue, or list of the prioritized errors in order from highest priority to lowest priority. Although operations 604 and 606 are described herein as being performed by the computing device 102, various examples are possible. In some examples, operations 604 and 606 are performed by the user device 126, such as when the notification of the error is transmitted to the user device 126 in operation 602a or 602b.

In operation 608, the computing device 102 transmits the generated list of prioritized errors to the user device 126. In some examples, upon receiving the list of prioritized errors, the UI 136 of the user device 126 presents a notification indicating new errors to be resolved.

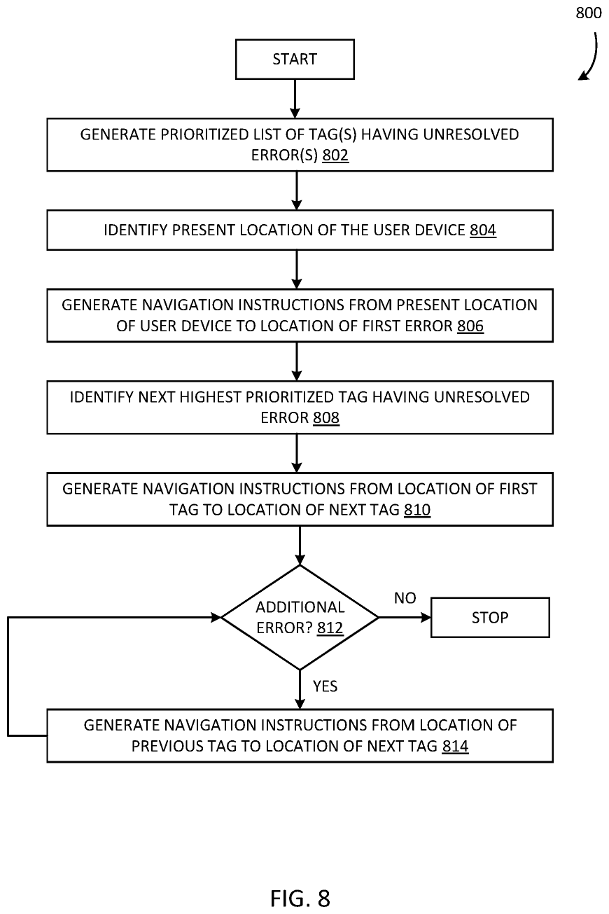

In operation 610, the computing device 102 generates navigation instructions from a present location of the user device 126 to a location of the first error on the prioritized list of errors. In some examples, the computing device 102 obtains data from the sensor 142 to determine a present location of the user device 126 and obtains data from the digital rail 146 or the standalone digital tag 150 associated with the first error to determine the physical location of the error. In some examples, the physical locations of the present location of the user device 126 and the error are presented as coordinates that are navigated to. In some examples, the physical locations of the present location of the user device 126 and the error are presented as an aisle and space identifier within the retail store. The navigation instructions are generated to provide an optimal route from the present location of the user device 126 to the location of the error, which minimizes the amount time required to traverse from the present location of the user device 126 to the location of the error or the distance to be traversed from the present location of the user device 126 to the location of the error. Generating the navigation instructions is described in greater detail below with regard to the description of FIG. 8. Although operation 610 is described herein as being performed by the computing device 102, various examples are possible. In some examples, operation 610 is performed by the user device 126, such as when the notification of the error is transmitted to the user device 126 in operation 602a or 602b. In operation 612, in examples where operations 604, 606, and 612 are executed by the computing device 102, the generated navigation instructions are transmitted to the user device 126.

It should be understood that operation 608 and operations 610-612 may be performed in any order without departing from the scope of the present disclosure, or by either the computing device 102 or the user device 126. In one example, the method 600 proceeds as shown in FIG. 6A, from operation 606 to 608 to 610 to 612. In another example, the method 600 proceeds from operation 606 to operation 610 and generates the navigation instructions, and then transmits the list of prioritized errors in operation 608 concurrently with the navigation instructions in operation 612. In another example, the notification of an error transmitted from the digital rail 146 or the standalone digital tag 150 is received by the user device 126 directly, which then prioritizes the tags having unresolved errors and generates navigation instructions to the highest priority tag having an unresolved error. In this example, operations 608 and 612 are omitted.

In operation 614, the error manager 132 presents the received navigation instructions via the UI 136 in response to a trigger event. In some examples, the trigger event is the reception of the navigation instructions or the reception of the indication of a tag having an error. In other examples, the trigger event is the user device 126 being turned on or receiving an input. In some examples, the navigation instructions are presented as static instructions, such as “Step 1: Proceed to Aisle 3; Step 2: Turn left onto Aisle 3” and so forth to direct the user device 126 to the location of the first error. In some examples, the navigation instructions are presented as dynamic instructions that update based on data received from the sensor 142 that updates, in real time, the present location of the user device 126.

In operation 616, upon the user device 126 arriving at the location of the first error, the UI 136 presents a list of error types. In some examples, the list of error types are stored as data 141 in the data storage device 140. For example, upon the location data of the sensor 142 matching the location data of the first error, the user device 126 determines the navigation instructions have been completed and the UI 136 updates to present the error types. In another example, the error types are presented in response to the UI 136 receiving an input indicating the user device 126 has arrived at the location of the present error.

In operation 618, the UI 136 receives a description of the first error, including a description of the digital tag 148 or the standalone digital tag 150 associated with the first error. In some examples, the description of the first error is received as a selection of multiple different descriptions, such as “Tag missing,” “Tag disconnected,” “Rail disconnected,” and so forth.

In operation 618, the computing device 102 diagnoses the error based on the received description received from the user device 126. The error is diagnosed as a standalone digital tag error, i.e., an error with a standalone digital tag 150, a digital rail error, or a digital tag error. In some examples, additional information is requested to more accurately diagnose the error. For example, if the error appears to be a digital rail error, additional information can be requested of the user device 126 to determine whether the digital rail error is a battery-related error.

In operation 620, illustrated in FIG. 6B, the computing device 102 or the user device 126 determines a recommended corrective action to resolve the determined error. The recommended corrective action may be determined based on mapping the determined error to corrective action data stored in the data storage device 114, such as an index of different errors and associated recommended corrective actions. As described herein, mapping references to generating the index of different errors and associated recommended corrective actions for each type of error. For example, a recommended corrective action for a rail error that is battery related is to reseat the rail battery, i.e., the battery 208, and determine if the error is corrected. As described herein, reseating the battery refers to reattaching the battery 208 to the digital rail 146. If, after reseating the battery 208, the error persists, the recommended corrective action is to replace the battery 208. The recommended corrective action for a missing digital tag 148 on the digital rail 146 or a digital tag 148 that is present but appears damaged is to add a new digital tag 148. The recommended corrective action for an error with a digital tag 148 that is present and appears in good condition is to reseat the digital tag 148 on the digital rail 146. If, after reseating the digital tag 148, the error persists, the error may be escalated or the digital tag 148 may be replaced. As referenced herein, reseating the digital tag 148 on the digital rail 146 refers to reattaching the digital tag 148 to the digital rail 146 such that the various components of the digital tag 148, including the power component 304, communication component 306, connector 308, and lighting component 310, are reconnected to the digital rail 146.

In operation 622, the computing device 102 generates instructions for implementing the recommended corrective action to resolve the diagnosed error. The generated instructions may include text, images, video, audio, or other outputs that provide and/or describe one or more steps of the recommended correction action to attempt to resolve the diagnosed error. For example, where the diagnosed error is a digital tag error and the recommended corrective action is to reseat the digital tag 148 on the digital rail 146, the generated instructions are “Fully remove digital tag from digital rail and reattach digital tag to digital rail in same location as previously attached”. In operation 624, the diagnosed error type, recommended corrective action and generated instructions are transmitted to the user device 126. In operation 626, the diagnosed error type, recommended corrective action and generated instructions are presented on the UI 136.

In operation 628, the user device 126 determines whether the error is resolved based on the corrective action being implemented. UI 136 receives an indication that the diagnosed error has been resolved and transmits the indication to the computing device 102. In some examples, the instructions presented on the UI 136 include a first prompt that, when selected, confirms the instructions have been implemented and the error has been resolved and a second prompt that, when selected, indicates the instructions have been implemented but the error has not been resolved. An input may be received selecting either the first prompt that serves as the indication that the diagnosed error has been resolved or the second prompt that serves as the indication the diagnosed error has not been resolved. In some examples, confirmation of the resolved error may be requested to close out the error notification. In this example, the image capturing device 144 captures an image or video of the physical location including the resolved error, i.e., the digital rail 146, digital tag 148, or standalone digital tag 150 operating correctly, and the captured image is transmitted in operation 628. In examples where the error is resolved, the method 600 proceeds to operations 630 and determines whether another unresolved error is open in the queue of errors. In examples where the error remains unresolved, the method 600 returns to operation 620 to determine a corrective action for the unresolved error.

In operation 630, the computing device 102 determines whether another unresolved error is presented in the queue of errors. In examples where another unresolved error is present in the queue of errors, i.e., a second highest priority error, operations 610-628 are repeated to resolve the next unresolved error. The method 600 continues until, at operation 630, no other unresolved errors are found in the queue. When no other unresolved errors are found, the method 600 terminates.

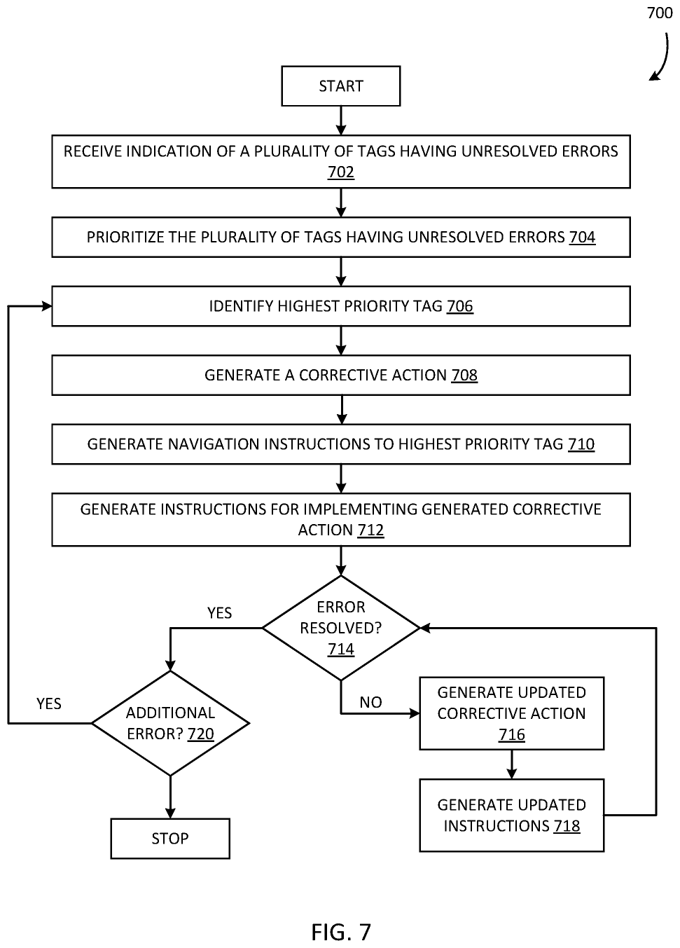

It should be understood that although described as being performed by the computing device 102, various operations may be performed by the user device 126. For example, the user device 126 may determine the corrective action and generate instructions that, when executed, implement the corrective action in order to resolve the diagnosed error. For example, FIG. 7 illustrates an example flow chart illustrating a method of resolving issues with digital tag systems according to an example. The method 700 illustrated in FIG. 7 is for illustration only. Other examples of the method 700 can be used without departing from the scope of the present disclosure. In some examples, the method 700 is implemented by one or more components of the system 100 illustrated in FIG. 1, such as the user device 126.

The method 700 begins by an error manager receiving an indication of one or more tags having unresolved errors in operation 702. In various examples, the indication is received by the error manager 132 or the error manager 115. In some examples, the indication is received from the standalone digital tag 150. In some examples, the indication is received from the digital rail 146 upon which the digital tag 148 having the unresolved error is mounted. The indication may indicate a single tag, i.e., a digital tag 148 or standalone digital tag 150, having an unresolved error or a plurality of tags, i.e., more than one digital tag 148 or standalone tag 150, having unresolved errors.

In operation 704, the error manager 132 prioritizes the plurality of tags having the unresolved errors. As described herein, the tags having the unresolved errors are prioritized according to various factors. In some examples, the tags are prioritized based on a type of item assigned to each tag in the plurality of tags. For example, the data storage device 140 and/or the data storage device 114 may store a hierarchy of items that is used to prioritize the tags of the associated items to resolve errors. The hierarchy of items may be generated based on a popularity of items, i.e., a quantity of items sold, a price of items, i.e., a sale price of each item, a category of item, i.e., household goods, groceries, school supplies, and so forth, or any other suitable method of identifying a particular item has a higher priority than another item.

In some examples, the tags are prioritized based on a location of the tags within the retail environment. For example, the error manager 132 may prioritize tags in one area of the retail environment higher than tags in another area of the retail environment. In one example, prioritization of tags is based on the hierarchy of items stored in the data storage device 140 and/or the data storage device 114. In another example, prioritization of tags is based on physical proximity to the user device 126. In other words, tags that are in closest physical proximity to the user device 126 are prioritized higher than tags further away from the user device 126 so that the errors associated with the tags in closest proximity may be resolved more quickly. For example, the error manager 132 determines the location of each tag having an unresolved error, dynamically identifies the tag having a nearest proximity to a present location of the user device 126, and assigns the tag having the nearest proximity to the present location of the user device 126 as the highest priority tag. The error manager 132 then identifies a second tag of the plurality of tags having unresolved errors having a nearest proximity to the location of the highest priority tag and designates, or assigns, the second tag as a second highest priority tag. The error manager 132 proceeds in this manner until all the tags having unresolved errors in the received indication are prioritized. In some examples, the error manager 132 generates a queue that includes the prioritized tags. In some examples, the queue is dynamically reprioritized as the user device 126 changes locations. For example, as the user device 126 moves to address a highest priority tag, the queue is updated to reflect the previously second-highest priority tag as newly the highest priority tag based on the updated location of the user device 126. In another example, the queue is dynamically reprioritized by anticipating the movement and change of location of the user device 126.

In operation 706, the error manager 132 identifies the highest priority tag. In some examples, the highest priority is the first tag in the generated queue, such as the tag in nearest proximity to the user device 126 or the tag associated with the highest item in the hierarchy of items as described herein.

In operation 708, the error manager 132 generates a corrective action for the identified highest priority tag. The generated corrective action is an action that is predicted to resolve the unresolved error. In some examples, the generated corrective action is an action that is generated based on the error type of the particular tag. For example, where the identified highest priority tag is a standalone digital tag 150, the generated corrective action is to replace the standalone digital tag 150 with a new, or second, standalone digital tag 150, as described in greater detail below. In another example, where the identified highest priority tag is a digital tag 148 mounted on a digital rail 146, the error manager 132 may implement the ML model 133 to identify other potential errors of tags mounted on the digital rail 146 to predict whether the error is an error with the digital rail 146 or with the digital tag 148 and, based on the prediction, generate the corrective action.

In operation 710, the error manager 132 generates navigation instructions to the identified highest priority tag. For example, the error manager 132 determines the location of the highest priority tag. In some examples, the location of the highest priority tag is included in the received indication of the error. In other examples, the location of the highest priority tag is not included in the received indication of the error and the error manager 132 obtains location information of the highest priority tag from a database stored in the data storage device 140 and/or the data storage device 114. The error manager 132 further determines a present location of the user device 126, such as by obtaining data from the sensor 142 indicating the present location of the user device 126. The error manager 132 then generates navigation instructions from the present location of the user device 126 to the location of the highest priority tag. In some examples, the navigation instructions are generated to minimize a time to arrive at the highest priority tag. In other examples, the navigation instructions are generated to minimize a distance to travel to arrive at the highest priority tag. For example, as the queue is dynamically reprioritized as the user device 126 changes locations, the navigation instructions are updated to navigate the user as the user device 126 moves to address a highest priority tag, or by anticipating the movement and change of location of the user device 126. In some examples, the time and distance are weighted in order to generate the navigation instructions.

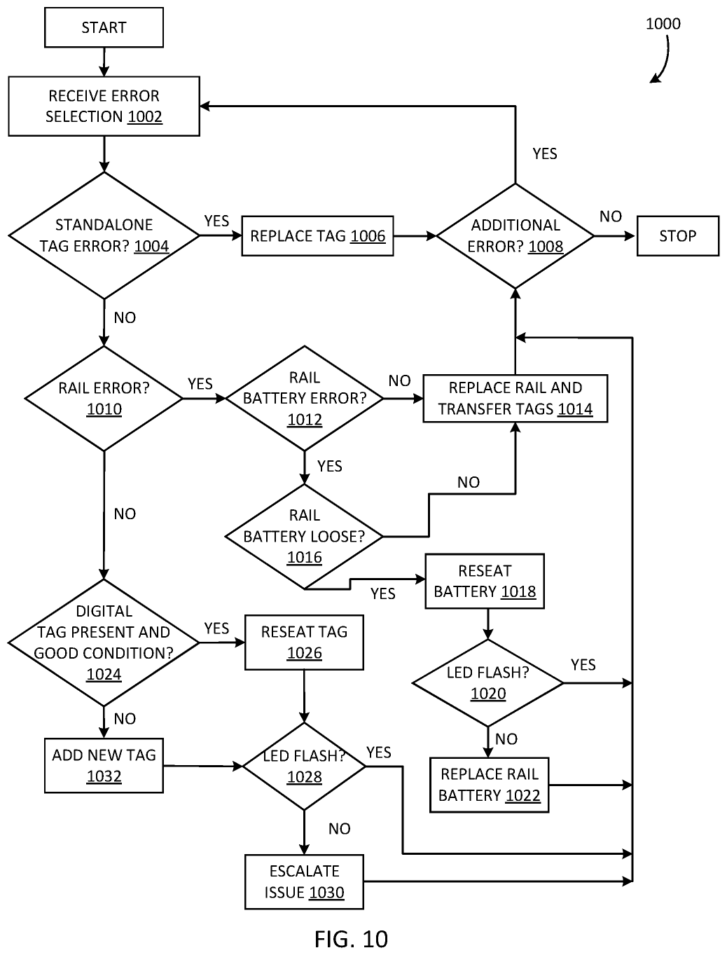

In operation 712, the error manager 132 generates instructions for implementing the corrective action. For example, as described herein, instructions for implementing a corrective action to replace a standalone digital tag 150 with a new, or second, standalone digital tag 150 include instructions to unlink, or unpair, the original standalone digital tag 150 with an item and then link, or pair, the new standalone digital tag 150 to the item. As another example, instructions for implementing a corrective action to reconnect a digital tag 148 to a digital rail 146 include instructions to reseat the digital tag 148 to the digital rail 146 and then determine whether the error is resolved. Various other examples of corrective actions and associated instructions are described in greater detail below with regards to FIG. 10.

It should be understood that although described herein as occurring in sequence from operation 708 to 710 to 712, various examples are possible. For example, the navigation instructions may be generated in operation 710 prior to generating the corrective action in operation 708 or after generating the instructions for implementing the corrective action in operation 712. In some examples, the navigation instructions are generated in operation 710 prior to generating the corrective action in operation 708 so that the corrective action and instructions to implement the corrective action are generated as the user device 126 proceeds along the navigation instructions to the identified highest priority tag. The generated corrective action, generated navigation instructions, and generated instructions are presented on the UI 136 to be followed and implemented by a user, such as a retail associate.

In operation 714, the error manager 132 determines whether the error is resolved upon receiving an indication of a completion of the generated instructions. In some examples, the UI 136 presents a first prompt that, when selected, indicates the instructions have been implemented and a second prompt that, when selected, identifies whether the error is resolved or remains unresolved. Where the error is unresolved, the method 700 proceeds to operation 716 and the error manager 132 generates second, or updated, corrective action to resolve the error for the highest priority tag. In operation 718, the error manager 132 generates updated, or second, instructions for implementing the second corrective action to resolve the error. The method 700 then returns to operation 714 and determines whether the error is resolved or remains unresolved based on the completion of the generated updated instructions.

Where the error is resolved, the method 700 proceeds to operation 720 and the error manager 132 determines whether an indication has been received of an additional tag having an unresolved error. In some examples, the error manager 132 determines whether a second highest priority tag is included in the queue. Where an additional tag having an unresolved error is identified, the method 700 returns to operation 706 and the error manager 132 identifies the next highest priority tag. Where no additional tags having an unresolved error are identified, the method 700 terminates.

FIG. 8 illustrates an example flow chart illustrating a method of generating navigation instructions for resolving issues with digital tag systems according to an example. The method 800 illustrated in FIG. 8 is for illustration only. Other examples of the method 800 can be used without departing from the scope of the present disclosure. In some examples, the method 800 is implemented by one or more components of the system 100 illustrated in FIG. 1, such as the computing device 102.

The method 800 begins by generating a prioritized list of tags having unresolved errors in operation 802. For example, as described herein, the computing device 102 prioritizes the tags having unresolved errors based on various factors that may be preconfigured or dynamically selected by a user, such as a retail associate using the user device 126 or a manager of the retail associate. In one example, the prioritization is based on physical proximity of location to the user device 126. This prioritization method prioritizes tags having unresolved errors that are able to be addressed quickly due to a physical proximity to the user device 126 that provides instructions for corrective actions. In this example, a first tag is prioritized as the highest-priority tag in the queue, a second tag that is nearest in proximity to the first tag is assigned a second highest priority in the queue, a third tag that is nearest in proximity to the second tag is assigned a third highest priority in the queue, and so forth until each tag having unresolved errors is assigned a priority in the queue. Accordingly, this example provides an ordered list of the most efficient manner in which the errors are to be addressed, minimizing wasted time and travel distance between each error.

In another example, the prioritization is based on an anticipated severity of the error. For example, an error with the digital rail 146 may be more highly prioritized than an error with the standalone digital tag 150 because the error with the digital rail 146 has the potential to affect multiple digital tags 148, while an error with the standalone digital tag 150 affects only a single tag, i.e., the standalone digital tag 150 that reports the error. In another example, the prioritization is based on a type of item associated with each error. For example, where two errors are received, the error associated with the item having a higher price or higher sale numbers is prioritized over the error associated with the item having a lower price or lower sale numbers, respectively. The computing device 102 generates a list of the prioritized tags having unresolved errors in order from highest priority to lowest priority.

In operation 804, the computing device 102 identifies a present location of the user device 126. For example, the computing device 102 receives location information obtained via the sensor 142 indicating a present location of the user device 126. In operation 806, the computing device 102 generates navigation instructions from the present location of the user device 126 to the location of the first error. In some examples, location information of the first error is included in the error information of the error. In some examples, the computing device 102 obtains data from the digital rail 146 or the standalone digital tag 150 associated with the highest prioritized error to determine the physical location of the respective error. The navigation instructions are generated to provide an optimal route from the present location of the user device 126 to the location of the error, which minimizes the amount time required to traverse from the present location of the user device 126 to the location of the error or the distance to be traversed from the present location of the user device 126 to the location of the error.

Some examples of the present disclosure recognize that the generated navigation instructions may be incorrectly, or inaccurately, followed as generated. In other words, the user device 126 may not traverse to the location of the highest priority tag as set forth in the generated navigation instructions. In some examples, the error manager 132 determines location information of the user device 126 based on data received from the sensor 142 and recalculates a highest priority tag based on the location of the user device 126. For example, where the current location of the user device 126 brings the user device 126 in close proximity to a tag assigned a lower priority in the queue, the tags in the queue may be reprioritized so that the tag in close proximity to the user device 126 is assigned the highest priority and updated navigation instructions are generated to direct the user device 126 to the newly-assigned highest priority tag. In other examples, the queue is not reprioritized, and the navigation instructions are dynamically updated to redirect the user device 126 to the tag assigned the highest priority.

In operation 808, the computing device 102 identifies a next error, i.e., a second error. In other words, the computing device identifies the error that has the second highest priority. In operation 810, the computing device 102 generates navigation instructions from the location of the first error to the location of the second error. The navigation instructions are generated in the same manner as the navigation instructions from the present location of the user device 126 to the first error, i.e., either to minimize the amount of time required to traverse from the location of the first error to the location of the second error or to minimize the distance to be traversed from the location of the first error to the location of the second error.

In operation 812, the computing device 102 determines whether the prioritized list of errors includes additional errors. In examples where the prioritized list of errors includes additional errors, the computing device 102 generates navigation instructions from the location of the second error to the next highest priority error, i.e., a third error, in operation 814. Following the generation of navigation instructions in operation 814, the method 800 returns to operation 812 and again determines whether the prioritized list of errors includes additional errors. Upon navigation instructions being navigated to the lowest priority error, so that no additional errors are found, the method 800 terminates. For example, in examples where the method 800 is an example of operation 608 illustrated in FIG. 6A, the method 600 proceeds to operation 610.

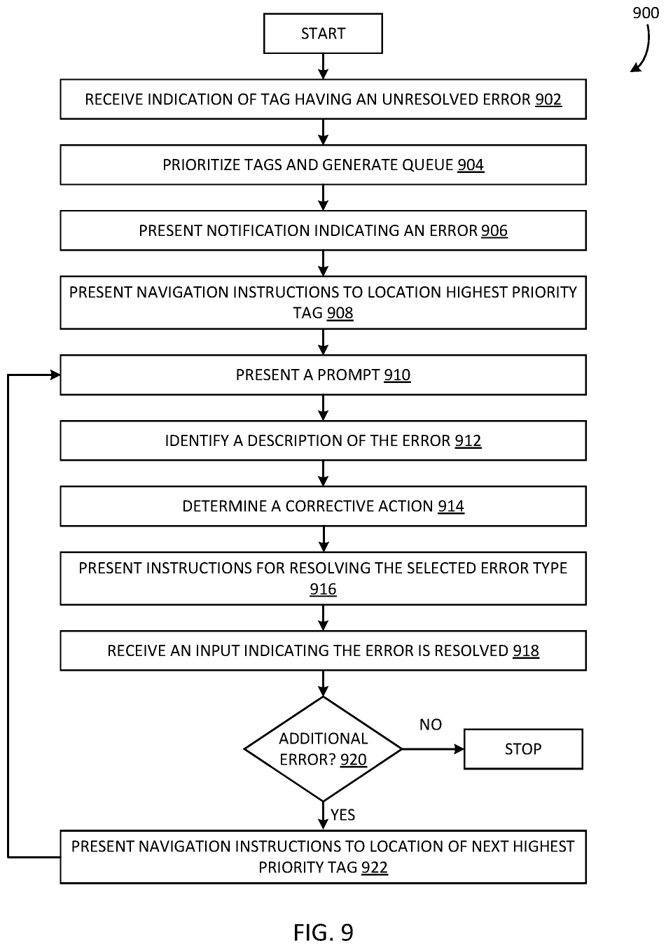

FIG. 9 illustrates an example flow chart illustrating a method of presenting a user interface (UI) with instructions for resolving defects with digital tag systems according to an example. The method 900 illustrated in FIG. 9 is for illustration only. Other examples of the method 900 can be used without departing from the scope of the present disclosure. In some examples, the method 900 is implemented by one or more components of the system 100 illustrated in FIG. 1, such as the user device 126.

The method 900 begins by the error manager 132 receiving an indication of a tag, or a plurality of tags, having errors to be resolved in operation 902. As described herein, the error manager 132 is a downloaded client-side version of the application 107. For example, the error manager 132 is an application that, when launched, presents the UI 136 on the user device 126. The UI 136 of the error manager 132 provides various information, including a map of a selected retail environment, information related to tags having unresolved errors as described herein, navigation instructions to navigate from a present location to a tag having an unresolved error, instructions on how to resolve an error, prompts that, when selected, select different error types or provide other information, and so forth. In some examples, the tag having the unresolved error is associated with a modular display, such as the display 145, and more particularly with at least one of the digital tag 148 mounted on the digital rail 146, the standalone digital tag 150, or the digital rail 146 included on the display 145 and upon which the digital tag 148 is mounted.

In operation 904, the error manager 132 identifies a plurality of tags having unresolved errors, prioritizes the identified tags as described herein, and generates a queue that includes the prioritized plurality of tags. In another example, the error manager 132 identifies a plurality of errors associated with one or more of the digital tag or the digital rail, prioritizes the identified plurality of errors, and generates a queue that includes the prioritized plurality of errors. As described herein, the error manager 132 may prioritize the plurality of errors, or the plurality of tags presenting an unresolved error, based on one or more of a variety of factors. For example, the errors may be prioritized based on physical proximity of location to the user device 126, based on an anticipated severity of the error, based on a type of item associated with each error, anticipated feasibility of the error being resolved by a user, and so forth.

In operation 906, the error manager 132 presents a notification via the UI 136. The notification indicates an error to be resolved with one or more of a digital rail 146, a digital tag 148, or a standalone digital tag 150. In some examples, the notification identifies that an error is present within the retail location. In some examples, the notification includes additional detail regarding the error, including a location of the error, an urgency of the error, a history of previous errors at the location of the error, and so forth. In some examples, the presented notification includes a prompt that, when selected, triggers the initiation of operation 908. In some examples, the notification includes only the highest priority error in the generated queue, or a select highest priority errors in the generated queue, such as the three or five highest priority errors. In other examples, the notification includes the entire generated queue of errors.

In operation 908, the UI 136 receives and presents navigation instructions to the location of a highest priority error in the queue, also referred to herein as a first error. For example, as described in greater detail herein, the navigation instructions provide an optimal route from the present location of the user device 126 to the location of the first error, which minimizes the amount time required to traverse from the present location of the user device 126 to the location of the first error or the distance to be traversed from the present location of the user device 126 to the location of the first error. In some examples, the navigation instructions are presented in response to the reception of an input selecting a prompt, such as an input signaling that a user of the user device 126 is ready to begin resolving an error.

In operation 910, upon the user device 126 reaching the location of the first error, the error manager 132 controls the UI 136 to present a prompt for a user to provide an input to the UI 136. In some examples, the error manager 132 determines the user device 126 has reached the location of the first error based on data received from the sensor 142. In other examples, the error manager 132 determines the user device 126 has reached the location of the first error based on the reception of input received at the UI 136, such as an input from a user. In some examples, the prompt is a prompt to provide details regarding the indicated error. The error types include a standalone tag error, a digital rail error, or an error of a digital tag 148 coupled to the digital rail 146. In some examples, the prompt includes selectable options for each error type. In some examples, the prompt is a prompt to enter information or details regarding the scene at the physical location, and the entered information is used to predict an error type. For example, the prompt requests information related to the scene of the error such as whether the digital tag 148 or digital rail 146 appear to be damaged, whether the digital tag 148 or digital rail 146 appear to be powered on, whether multiple digital tags 148 on a single digital rail 146 appear to not be connected, and so forth. In some examples, the prompt is a prompt to select an error type.

In operation 912, the error manager 132 identifies a description of the error based on the selection of the prompt. In some examples, the error manager 132 utilizes an ML model to identify the description of the error based on previous scenes of errors that have since been resolved. For example, where the scene includes a digital rail 146 with multiple digital tags 148 presenting errors, the ML model of the error manager 132 identifies a description of error as a digital rail error because feedback from previous scenes indicate that when multiple digital tags 148 present errors on a single digital rail 146, there is a strong likelihood that the error is a digital rail error.

In operation 914, the error manager 132 determines a recommended corrective action to resolve the error based on the identified description of the error. As described herein, the recommended corrective action may be determined based on data stored in the data storage device 114 or the data storage device 140, such as an index of different errors and associated corrective actions. To determine the recommended corrective action, the error manager 132 obtains the associated recommended corrective actions for the particular error from either the data storage device 114 or the data storage device 140.

In operation 916, the UI 136 presents instructions for resolving the selected error type using the recommended corrective action. In some examples, the instructions presented are instructions for a user to follow that, when implemented, perform the recommended corrective action specific to the selected error type. As described herein, the recommended corrective action for an error with a standalone digital tag 150 is to replace the standalone digital tag 150. The recommended corrective action for a rail error that is not battery related is to replace the digital rail 146 and transfer the digital tags 148 associated with the original digital rail 146 to the new digital rail 146. The recommended corrective action for a rail error that is battery related is to reseat the rail battery, i.e., the battery 208, and determine if the error is corrected. If, after reseating the battery 208, the error persists, the recommended corrective action is to replace the battery 208. The recommended corrective action for a missing digital tag 148 on the digital rail 146 or a digital tag 148 that is present but appears damaged is to add a new digital tag 148. The recommended corrective action for an error with a digital tag 148 that is present and appears in good condition is to reseat the digital tag 148 on the digital rail 146. If, after reseating the digital tag 148, the error persists, the error may be escalated or the digital tag 148 may be replaced.

In some examples, the presented instructions include a prompt that, when selected, indicates the error has been resolved by following the presented instructions. In operation 918, the UI 136 receives an input indicating the error has been resolved. In some examples, the received input is a selection of the prompt presented at the end of the instructions.

In operation 920, the user device 126 determines whether the list of errors in the generated queue includes an additional error. Where an additional error is found, the method 900 proceeds to operation 922 and obtains and presents navigation instructions to the location of the next error. The method 900 returns to operation 910 and, upon the user device 126 reaching the location of the next error, the UI 136 presents a prompt for a user to provide an input to the UI 136. In examples where no additional errors are found, the method 900 terminates.

FIG. 10 illustrates an example flow chart illustrating a method of identifying an error type and presenting a UI with instructions for resolving the identified error type according to an example. The method 1000 illustrated in FIG. 10 is for illustration only. Other examples of the method 1000 can be used without departing from the scope of the present disclosure. In some examples, the method 1000 is implemented by one or more components of the system 100 illustrated in FIG. 1, such as the user device 126. In some examples, the method 1000 is an example of operations 910 and 912 illustrated in FIG. 9.

The method 1000 begins by the UI 136 receiving an error type selection in operation 1002. In some examples, the error selection is received as the selection of a prompt presented on the UI in response to detecting the user device 126 has arrived at a location of an error. The selection of the error type includes a standalone tag error, a digital rail error, and an error with a digital tag 148 mounted on a digital rail 146. In some examples, the error selection is performed by the error manager 132 based on an image of a scene including the error that is captured by the image capturing device 144.

In operation 1004, the user device 126 determines whether the selected error is an error with a standalone digital tag 150. In examples where the selected error is an error associated with a standalone digital tag 150, in operation 1006 the UI 136 obtains from the database on the data storage device 114, instructions for resolving the error and presents the instructions. For example, the instructions for resolving an error associated with the standalone digital tag 150 are to replace the standalone digital tag 150 with a new, or second, standalone digital tag 150. Following an input being received at the UI 136 confirming the standalone digital tag 150 has been replaced, the user device 126 determines whether an additional error is to be resolved in operation 1008. Where there are no additional errors to be resolved, the method 1000 terminates. Where there is an additional error to be resolved, the method 1000 returns to operation 1002 and prepares for a next iteration of an error selection.

In some examples, the error is determined to be a standalone digital tag error or not a standalone digital tag error in response to the selection of a prompt presented on the UI 136, such as by a user. In other examples, the error is determined to be a standalone digital tag error or not a standalone digital tag error based on an image of the error site captured by the image capturing device 144 of the user device 126. For example, the image capturing device 144 captures an image of the error site and the image is analyzed by the processor 134 to identify the tag present in the error is a standalone digital tag 150 and the method 1000 proceeds to operation 1006. In another example, the image capturing device 144 captures an image of the error site and the image is analyzed by the processor 134 to identify the tag present in the error is not a standalone digital tag 150 and the method 1000 proceeds to operation 1010.

In examples where the selected error is not an error associated with a standalone digital tag 150 in operation 1004, the method 1000 proceeds to operation 1010 where the UI 136 presents instructions including a selectable prompt to determine whether the selected error is an error associated with a digital rail 146. In some examples, the error is determined to be a digital rail error or not a digital rail error in response to the selection of a prompt presented on the UI 136, such as by a user. In other examples, the error is determined to be a digital rail error or not a digital rail error based on an image of the error site captured by the image capturing device 144 of the user device 126. For example, the image capturing device 144 captures an image of the error site and the image is analyzed by the processor 134 to identify the error appears to be an error with the digital rail 146 and the method 1000 proceeds to operation 1012. In another example, the image capturing device 144 captures an image of the error site and the image is analyzed by the processor 134 to identify the error appears to not be an error with the digital rail 146 and the method 1000 proceeds to operation 1024. For example, the processor 134 analyzes the image captured by the image capturing device 144 to determine whether a single digital tag 148 is presenting as an error to be resolved or whether a plurality of digital tags 148 on a single digital rail 146 present as errors to be resolved. A single digital tag 148 presenting as an error indicates a greater likelihood that the error is with the tag itself, while multiple digital tags 148 on a single digital rail 146 presenting as errors indicates a greater likelihood that the error is with the digital rail 146, causing additional iterations of errors with digital tags 148 associated with the digital rail 146.

In examples where the selected error is an error associated with a digital rail 146, in operation 1012 the UI 136 presents a selectable prompt requesting an input to select a subtype error as described herein, i.e., whether the error is an error with the battery 208 of the digital rail 146.

Where the error is determined to not be a battery 208 error, such as by the reception of an input to the UI 136 selecting “Not a Rail Battery Error” or similar, or excluded as the predicted error type, in operation 1014 the UI 136 obtains from the database on the data storage device 114, instructions for resolving the error and presents the instructions. For example, the instructions for resolving an error associated with a digital rail 146 that is not a rail battery error are to replace the digital rail 146 and then replace the digital tags 148 associated with the previous digital rail 146 by associating the digital tags 148 with the new, or second, digital rail 146. Following an input being received at the UI 136 confirming the digital rail 146 has been replaced and the digital tags 148 have been associated with the new digital rail 146, the user device 126 determines whether an additional error is to be resolved in operation 1008. Where there are no additional errors to be resolved, the method 1000 terminates. Where there is an additional error to be resolved, the method 1000 returns to operation 1002 and prepares for a next iteration of an error selection.

Where the error is determined to be a battery 208 error, such as by the reception of an input to the UI 136 selecting “Rail Battery Error” or based on analysis of the error site captured by the image capturing device 144, in operation 1012, the method 1000 proceeds to operation 1016 where the UI 136 obtains, from the database on the data storage device 114, instructions for resolving the error and presents the instructions. For example, the instructions for resolving an error associated with a digital rail 16 that is predicted to be a rail battery error are to determine whether the battery 208 is loose, i.e., whether the battery 208 is not seated correctly. Where the error is determined to not be a loose battery 208 error, such as based on analysis of the error site captured by the image capturing device 144 or by the reception of an input to the UI 136 selecting “Not a Loose Battery Error” or similar, the method 1000 proceeds to operation 1014 and the UI 136 obtains, from the database on the data storage device 114, instructions for resolving the error and presents the instructions. For example, the instructions are to replace the digital rail 146 and replace the digital tags 148 associated with the previous digital rail 146 by associating the digital tags 148 with the new digital rail 146. Following an input being received at the UI 136 confirming the digital rail 146 has been replaced and the digital tags 148 have been associated with the new digital rail 146, the user device 126 determines whether an additional error is to be resolved in operation 1008. Where there are no additional errors to be resolved, the method 1000 terminates. Where there is an additional error to be resolved, the method 1000 returns to operation 1002 and prepares for a next iteration of an error selection. Where the error in operation 1016 is determined to be a loose battery 208, such as by the reception of an input to the UI 136 selecting “Loose Battery Error” or similar, the method 1000 proceeds to operation 1018 where the UI 136 obtains, from the database on the data storage device 114, instructions for resolving the error and presents the instructions. For example, the instructions are to reseat the battery 208 of the digital rail 146. Following a confirmation that the battery 208 has been reseated, such as by the selection of a prompt included in the instructions presented in operation 1018, the UI 136 presents instructions to determine whether the lighting component 204, such as the LED, has flashed or is flashing on the digital rail 146 in operation 1020.

Where an input is received at the UI 136 selecting that the lighting component 204 is flashing or has flashed, or an analysis of the error site captured by the image capturing device 144 indicates the lighting component 204 is flashing or has flashed, indicating the battery 208 has been reseated and reconnected, the method 1000 returns to operation 1008. Where an input is received at the UI 136 selecting that the lighting component 204 is not flashing or has not flashed, indicating the battery 208 has not been reconnected, in operation 1022 the UI 136 obtains from the database on the data storage device 114, instructions for resolving the error and presents the instructions. For example, the instructions are to replace the digital rail 146 and replace the digital tags 148 associated with the previous digital rail 146 by associating the digital tags 148 with the new digital rail 146. Following an input being received at the UI 136 confirming the digital rail 146 has been replaced and the digital tags 148 have been associated with the new digital rail 146, the method 1000 returns to operation 1008.

In examples where the selected error is not an error associated with a digital rail 146 in operation 1010, the method 1000 proceeds to operation 1024 where the UI 136 obtains, from the database on the data storage device 114, instructions for resolving the error and presents the instructions. For example, the instructions include a selectable prompt to determine whether the digital tag 148 is both present and in good condition. In some examples, the digital tag 148 is determined to be both present and in good condition in response to the selection of a prompt presented on the UI 136, such as by a user. In other examples, the digital tag 148 is determined to be either not present or not in good condition in response to analysis of an image of the error site captured by the image capturing device 144 of the user device 126. For example, the image capturing device 144 captures an image of the error site and the image is analyzed by the processor 134 to identify the digital tag 148 is both present and in good condition and the method 1000 proceeds to operation 1026. In another example, the image capturing device 144 captures an image of the error site and the image is analyzed by the processor 134 to identify the digital tag 148 is cither not present or not in good condition and the method 1000 proceeds to operation 1032.

In examples where an input is received at the UI 136 indicating the digital tag 148 is present and in good condition, in operation 1026 the UI 136 obtains from the database on the data storage device 114, instructions for resolving the error and presents the instructions. For example, the instructions for resolving an error associated with a digital tag 148 that is present and in good condition are to reseat the digital tag 148 on the associated digital rail 146. Following the selection of a prompt indicating the digital tag 148 has been reseated on the associated digital rail 146, in operation 1028 the UI 136 presents obtains and instructions including a selectable prompt to indicate whether the lighting component 310, such as the LED on the digital tag 148, has flashed or is flashing, to indicate the digital tag 148 has been reseated and reconnected. Where a selection is received that the lighting component 310 has flashed or is flashing, or an analysis of the error site captured by the image capturing device 144 indicates the lighting component 204 is flashing or has flashed, the method 1000 proceeds to operation 1008 where the user device 126 determines whether an additional error is to be resolved. Where a selection is received that the lighting component 310 has not flashed or is not flashing, in operation 1030 the user device 126 escalates the issue. In some examples, escalating the issue includes sending a notification to the computing device 102 that additional service is required to correct the issue.

In examples where, in operation 1024, an input is received at the UI 136 indicating the digital tag 148 is not present or is not in good condition, i.e., is damaged, in operation 1032 the UI 136 obtains from the database on the data storage device 114, instructions for resolving the error and presents the instructions. For example, the instructions for resolving an error associated with a digital tag 148 that either not present or not in good condition are to add a new digital tag 148 on the associated digital rail 146 to replace the digital tag 148 that is not present or in good condition. Following the selection of a prompt indicating the new digital tag 148 has been added to the associated digital rail 146, the method 1000 proceeds to operation 1028 as described herein.

In some examples, the inputs received on the UI 136 are received from a user, such as a retail associate, operating the user device 126 and executing the instructions presented on the UI 136. In other examples, the inputs received on the UI 136 are received from an external device, such as the external device 152. As described herein, the external device 152 may be an automated electronic device such as a robot operable to receive and follow instructions to resolve defects and errors with digital tag 148, standalone digital tag 150, or digital rails 146.

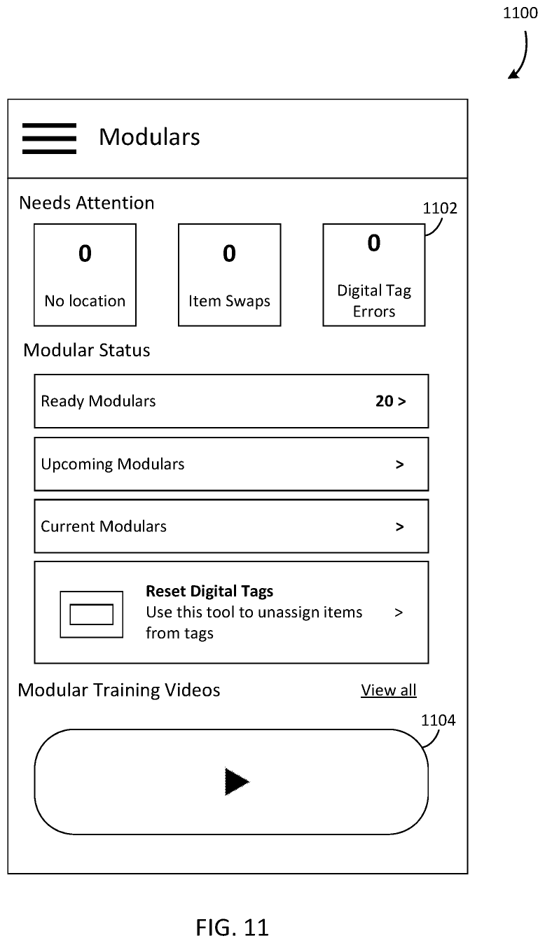

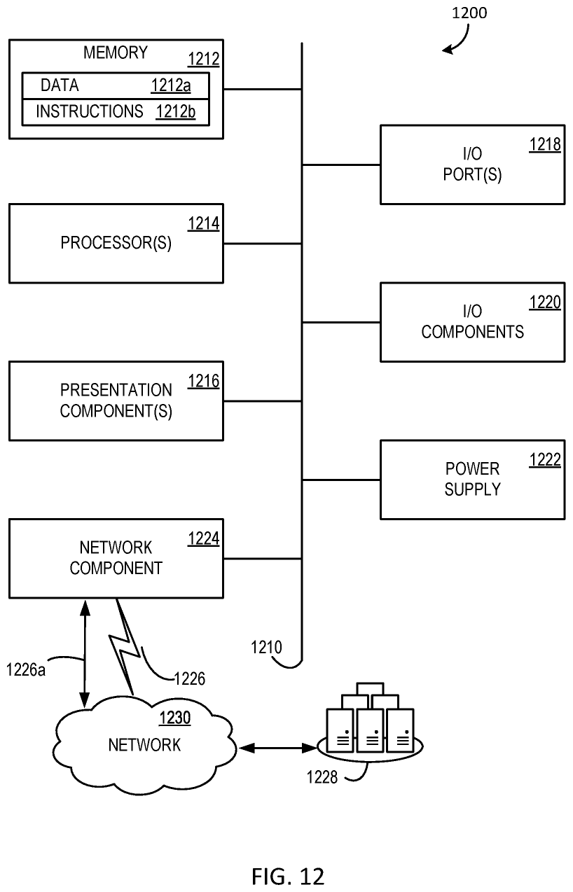

FIG. 11 illustrates an example user interface (UI) according to an example. The UI 1100 illustrated in FIG. 11 is for illustration only. Various examples of the UI 1100 may be used without departing from the scope of the present disclosure. In some examples, the UI 1100 is an example of the UI 136 that presents a client-side version of the error manager 132 that presents instructions for identifying and resolving errors with a digital rail 146, digital tag 148, and standalone digital tag 150 as described herein.

The UI 1100 includes a digital tag errors section 1102 indicating a number of errors in the queue to be resolved. As illustrated in FIG. 11, the queue includes zero digital errors. The UI 1100 further includes an image capture section 1104 that presents a visual of the image capturing device 144. For example, when selected, the image capture section 1104 presents a visual representation of the image to be captured by the image capturing device 144 in order to scan a barcode, capture an image of an error site for analysis by the processor 134, and so forth.

### Exemplary Operating Environment

FIG. 12 is a block diagram of an example computing device 1200 for implementing aspects disclosed herein and is designated generally as computing device 1200. Computing device 1200 is an example of a suitable computing environment and is not intended to suggest any limitation as to the scope of use or functionality of the examples disclosed herein. Neither should computing device 1200 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

In some examples, the computing device 1200 is the computing device 102 and/or the user device 126. Accordingly, the memory 1212, the processor 1214, the presentation component(s) 1216, and the network 1230 can be the memory 104 or the memory 128, the processor 108 or the processor 134, the user interface 110 or the user interface 136, and the network 124, respectively. However, these examples should not be construed as limiting. Various examples are possible.

Computing device 1200 includes a bus 1210 that directly or indirectly couples the following devices: computer-storage memory 1212, one or more processors 1214, one or more presentation components 1216, I/O ports 1218, I/O components 1220, a power supply 1222, and a network component 1224. While computing device 1200 is depicted as a seemingly single device, multiple computing devices 1200 may work together and share the depicted device resources. For example, memory 1212 may be distributed across multiple devices, and processor(s) 1214 may be housed with different devices.

Bus 1210 represents what may be one or more buses (such as an address bus, data bus, or a combination thereof). Although the various blocks of FIG. 12 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 12 and the references herein to a “computing device.” Memory 1212 may take the form of the computer storage media references below and operatively provide storage of computer-readable instructions, data structures, program modules and other data for computing device 1200. In some examples, memory 1212 stores one or more of an operating system, a universal application platform, or other program modules and program data. Memory 1212 is thus able to store and access data 1212a and instructions 1212b that are executable by processor 1214 and configured to carry out the various operations disclosed herein.

In some examples, memory 1212 includes computer storage media in the form of volatile and/or nonvolatile memory, removable or non-removable memory, data disks in virtual environments, or a combination thereof. Memory 1212 may include any quantity of memory associated with or accessible by computing device 1200. Memory 1212 may be internal to computing device 1200, external to computing device 1200, or both. Examples of memory 1212 in include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1200. Additionally, or alternatively, memory 1212 may be distributed across multiple computing devices 1200, for example, in a virtualized environment in which instruction processing is carried out on multiple computing devices 1200. For the purposes of this disclosure, “computer storage media,” “computer-storage memory,” “memory,” and “memory devices” are synonymous terms for computer-storage memory 1212, and none of these terms include carrier waves or propagating signaling.

Processor(s) 1214 may include any quantity of processing units that read data from various entities, such as memory 1212 or I/O components 1220 and may include CPUs and/or GPUs. Specifically, processor(s) 1214 are programmed to execute computer-executable instructions for implementing aspects of the disclosure. The instructions may be performed by the processor, by multiple processors within computing device 1200, or by a processor external to client computing device 1200. In some examples, processor(s) 1214 are programmed to execute instructions such as those illustrated in the in the accompanying drawings. Moreover, in some examples, processor(s) 1214 represent an implementation of analog techniques to perform the operations described herein. For example, the operations may be performed by an analog computing device 1200 and/or a digital computing device 1200. Presentation component(s) 1216 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1200, across a wired connection, or in other ways. I/O ports 1218 allow computing device 1200 to be logically coupled to other devices including I/O components 1220, some of which may be built in. Example I/O components 1220 include, for example but without limitation, a microphone, joystick, game pad, satellite dish, scanner, printer, wireless device, etc.

Computing device 1200 may operate in a networked environment via network component 1224 using logical connections to one or more remote computers. In some examples, network component 1224 includes a network interface card and/or computer-executable instructions (e.g., a driver) for operating the network interface card. Communication between computing device 1200 and other devices may occur using any protocol or mechanism over any wired or wireless connection. In some examples, network component 1224 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1224 communicates over wireless communication link 1226 and/or a wired communication link 1226a to a cloud resource 1228 across network 1230. Various different examples of communication links 1226 and 1226a include a wireless connection, a wired connection, and/or a dedicated link, and in some examples, at least a portion is routed through the internet.

In some examples, the present disclosure includes a method comprising receiving, from a digital rail, an indication of a plurality of tags having unresolved errors; prioritizing, by an error manager implemented on a processor, the plurality of tags having the unresolved errors based at least in part on a type of item assigned to each tag in the plurality of tags, wherein the plurality of tags are associated with a plurality of modular displays, each modular display including at least one digital rail, the at least one digital rail associated with at least one tag of the plurality of tags; identifying, by the error manager, a highest priority tag from the prioritized plurality of tags; generating, by the error manager, a corrective action for the highest priority tag; and generating, by the error manager, instructions for implementing the generated corrective action, wherein the generated instructions are presented on a user interface (UI) of a user device.

In some examples, the present disclosure includes a system comprising a user interface (UI) implemented on a user device, a memory, and a processor communicatively coupled to the memory, and an error manager, implemented on the processor, operable to: receive, from a digital rail, an indication of a plurality of tags having unresolved errors; prioritize the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags; identify a highest priority tag from the prioritized plurality of tags; generate a corrective action for the highest priority tag; and generate instructions for implementing the generated corrective action, wherein the generated instructions are presented on the UI of the user device.

In some examples, the present disclosure includes a computer-readable storage medium having computer-executable instructions that, upon execution by a processor, cause the processor to receive, from a digital rail, an indication of a plurality of tags having unresolved errors; prioritize, by an error manager implemented on the processor, the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags; identify a highest priority tag from the prioritized plurality of tags; generate a corrective action for the highest priority tag; determine a location of the highest priority tag; determine a present location of a user device; and generate navigation instructions from the present location of the user device to the location of the highest priority tag; and generate instructions for implementing the generated corrective action, wherein the generated instructions and the generated navigation instructions are presented on a user interface (UI) of a user device.

Alternatively, or in addition to the other examples described herein, examples include any combination of the following:
wherein the method further comprises determining a location of the highest priority tag; determining a present location of the user device; and generating navigation instructions from the present location of the user device to the location of the highest priority tag;
wherein the method further comprises, upon receiving an indication of a completion of the generated instructions, generating a second corrective action to resolve an error of a second highest priority tag; and generating second instructions for implementing the generated second corrective action;
wherein the method further comprises generating second navigation instructions from the location of the highest priority tag to a location of the second highest priority tag;
wherein the method further comprises further prioritizing the plurality of tags based on a location of each tag in a retail environment;
wherein prioritizing the plurality of tags having the unresolved errors further comprises determining the location of each tag having the unresolved errors; identifying a tag having a nearest proximity to a present location of the user device; and assigning the highest priority to the tag having the nearest proximity to the present location of the user device;
wherein the method further comprises identifying a second tag of the plurality of tags having the unresolved errors that has a nearest proximity to the location of the highest priority tag; and designating the identified second tag as a second highest priority tag; and
wherein the method further comprises, in response to an indication that the generated instructions are completed, and an unresolved error of the highest priority tag remains unresolved, generating updated instructions for the highest priority tag, the updated instructions including a second corrective action.

As indicated above, program code instructions may be stored in memory, and executed by processing circuitry that is thereby programmed, to implement functions of the systems, subsystems, tools, and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded, and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. It will also be understood that one or more functions, and combinations of functions, may be implemented by special purpose hardware-based computer systems and/or processing circuitry s which perform the specified functions, or combinations of special purpose hardware and program code instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer-readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. As an illustration, the above-described implementations (and/or aspects thereof) are usable in combination with each other. In addition, many modifications are practicable to adapt a particular situation or material to the teachings of the various implementations of the disclosure without departing from their scope. While the dimensions and types of materials described herein are intended to define the parameters of the various implementations of the disclosure, the implementations are by no means limiting and are exemplary implementations. Many other implementations will be apparent to those of ordinary skill in the art upon reviewing the above description. The scope of the various implementations of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the disclosure, including the best mode, and also to enable any person of ordinary skill in the art to practice the various implementations of the disclosure, including making and using any devices or systems and performing any incorporated methods. The patentable scope of the various implementations of the disclosure is defined by the claims, and includes other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

Although the present disclosure has been described with reference to various implementations, various changes and modifications can be made without departing from the scope of the present disclosure.

What is claimed is:

1. A computer-implemented method comprising:
receiving, from a digital rail, an indication of a plurality of tags having unresolved errors;
prioritizing, by an error manager implemented on a processor, the plurality of tags having the unresolved errors based at least in part on a type of item assigned to each tag in the plurality of tags, wherein the plurality of tags are associated with a plurality of modular displays, each modular display including at least one digital rail, the at least one digital rail associated with at least one tag of the plurality of tags;
identifying, by the error manager, a highest priority tag from the prioritized plurality of tags;
generating, by the error manager, a corrective action for the highest priority tag; and
generating, by the error manager, instructions for implementing the generated corrective action, wherein the generated instructions are presented on a user interface (UI) of a user device.

2. The computer-implemented method of claim 1 further comprising:
determining a location of the highest priority tag;
determining a present location of the user device; and
generating navigation instructions from the present location of the user device to the location of the highest priority tag.

3. The computer-implemented method of claim 2 further comprising:
upon receiving an indication of a completion of the generated instructions, generating a second corrective action to resolve an error of a second highest priority tag; and
generating second instructions for implementing the generated second corrective action.

4. The computer-implemented method of claim 3 further comprising:
generating second navigation instructions from the location of the highest priority tag to a location of the second highest priority tag.

5. The computer-implemented method of claim 1 further comprising:
further prioritizing the plurality of tags based on a location of each tag in a retail environment.

6. The computer-implemented method of claim 5 wherein prioritizing the plurality of tags having the unresolved errors further comprises:
determining the location of each tag having the unresolved errors;
identifying a tag having a nearest proximity to a present location of the user device; and
assigning the highest priority to the tag having the nearest proximity to the present location of the user device.

7. The computer-implemented method of claim 6 further comprising:
identifying a second tag of the plurality of tags having the unresolved errors that has a nearest proximity to the location of the highest priority tag; and
designating the identified second tag as a second highest priority tag.

8. The computer-implemented method of claim 1 further comprising:
in response to an indication that the generated instructions are completed and an unresolved error of the highest priority tag remains unresolved, generating updated instructions for the highest priority tag, the updated instructions including a second corrective action.

9. A system comprising:
a user interface (UI) implemented on a user device;
a memory;
a processor coupled to the memory; and
an error manager, implemented on the processor, operable to:
receive, from a digital rail, an indication of a plurality of tags having unresolved errors;
prioritize the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags;
identify a highest priority tag from the prioritized plurality of tags;
generate a corrective action for the highest priority tag; and
generate instructions for implementing the generated corrective action, wherein the generated instructions are presented on the UI of the user device.

10. The system of claim 9 wherein the error manager is further operable to:
determine a location of the highest priority tag;
determine a present location of the user device; and
generate navigation instructions from the present location of the user device to the location of the highest priority tag.

11. The system of claim 10 wherein the error manager is further operable to:
upon receiving an indication of a completion of the generated instructions, generate a second corrective action to resolve an error of a second highest priority tag; and
generate second instructions for implementing the generated second corrective action.

12. The system of claim 11 wherein the error manager is further operable to:
generate second navigation instructions from the location of the highest priority tag to a location of the second highest priority tag.

13. The system of claim 9 wherein, to prioritize the plurality of tags having unresolved error, the error manager is further operable to:
determine the location of each tag having the unresolved errors;
identify a tag having a nearest proximity to a present location of the user device; and
assign the highest priority to the tag having the nearest proximity to the present location of the user device.

14. The system of claim 13 wherein the error manager is further operable to:
identify a second tag of the plurality of tags having the unresolved errors that has a nearest proximity to the location of the highest priority tag; and
designate the identified second tag as a second highest priority tag.

15. The system of claim 9 wherein the error manager is further operable to:
in response to an indication that the generated instructions are completed and an unresolved error of the highest priority tag remains unresolved, generate updated instructions for the highest priority tag, the updated instructions including a second corrective action.

16. A computer-readable storage medium storing instructions that, upon execution by a processor, cause the processor to:
receive, from a digital rail, an indication of a plurality of tags having unresolved errors;
prioritize, by an error manager implemented on the processor, the plurality of tags having the unresolved errors based at least in part on a type of item assigned to each tag in the plurality of tags and a location of each tag in a retail environment, wherein the plurality of tags are associated with a plurality of modular displays, each modular display including at least one digital rail, the at least one digital rail associated with at least one tag of the plurality of tags;
identify a highest priority tag from the prioritized plurality of tags;
generate a corrective action for the highest priority tag;
determine a location of the highest priority tag;
determine a present location of a user device;
generate navigation instructions from the present location of the user device to the location of the highest priority tag; and
generate instructions for implementing the generated corrective action, wherein the generated instructions and the generated navigation instructions are presented on a user interface (UI) of a user device.

17. The computer-readable storage medium of claim 16 wherein the instructions further cause the processor to:
upon receiving an indication of a completion of the generated instructions, generate a second corrective action to resolve an error of a second highest priority tag; and
generate second instructions for implementing the generated second corrective action.

18. The computer-readable storage medium of claim 17 wherein the instructions further cause the processor to:
generate second navigation instructions from the location of the highest priority tag to a location of the second highest priority tag.

19. The computer-readable storage medium of claim 16 wherein, to prioritize the plurality of tags having the unresolved error, the instructions further cause the processor to:
determine the location of each tag having the unresolved errors;
identify a tag having a nearest proximity to a present location of the user device; and
assign the highest priority to the tag having the nearest proximity to the present location of the user device.

20. The computer-readable storage medium of claim 16 wherein the instructions further cause the processor to:
in response to an indication that the generated instructions are completed and an unresolved error of the highest priority tag remains unresolved, generate updated instructions for the highest priority tag, the updated instructions including a second corrective action.
